(19) United States
(12) Patent Application Publication
(10) Pub. No.: US 2013/0039291 A1
(43) Pub. Date: Feb. 14, 2013

(54) Design on Enhanced Control Channel for Wireless System

(71) Applicants: Yufei Wu Blankenship, Kildeer, IL (US); Shiwei Gao, Nepean (CA); Sophie Vrzic, Ottawa (CA); Hua Xu, Ottawa (CA); Dongsheng Yu, Nepean (CA)

(72) Inventors: Yufei Wu Blankenship, Kildeer, IL (US); Shiwei Gao, Nepean (CA); Sophie Vrzic, Ottawa (CA); Hua Xu, Ottawa (CA); Dongsheng Yu, Nepean (CA)

(73) Assignee: RESEARCH IN MOTION LIMITED, Waterloo (CA)

(21) Appl. No.: 13/545,577

(22) Filed: Jul. 10, 2012

Related U.S. Application Data
(60) Provisional application No. 61/523,118, filed on Aug. 12, 2011.

(51) Int. Cl. H04W 72/04

(52) U.S. Cl. 370/329

(57) ABSTRACT

A method is provided for communication in a cell in a wireless telecommunication system. The method comprises, in a region that would otherwise carry a PDSCH, the region being defined by a number of resource blocks and a number of OFDM symbols, instead transmitting at least one of an uplink grant and a downlink assignment in a plurality of OFDM symbols within a first slot, a second slot, or both slots of the region, wherein the region can use either localized or distributed resources, and wherein the region contains one of: a transmission point-specific reference signal; a UE-specific reference signal; and a cell-specific reference signal.

### CROSS-REFERENCE TO RELATED APPLICATIONS

The present application claims priority to U.S. Provisional Patent Application No. 61/523,118, filed Aug. 12, 2011 by Yufei Wu Blankenship, et al., entitled “Enhanced Control Channel for Wireless System” which is incorporated by reference herein as if reproduced in its entirety.

### FIELD OF THE DISCLOSURE

The present disclosure relates to a physical downlink control channel in wireless telecommunications systems.

### BACKGROUND

As used herein, the term “user equipment” (alternatively “UE”) might in some cases refer to mobile devices such as mobile telephones, personal digital assistants, handheld or laptop computers, and similar devices that have telecommunications capabilities. Such a UE might include a device and its associated removable memory module, such as but not limited to a Universal Integrated Circuit Card (UICC) that includes a Subscriber Identity Module (SIM) application, a Universal Subscriber Identity Module (USIM) application, or a Removable User Identity Module (R-UIM) application. Alternatively, such a UE might include the device itself without such a module. In other cases, the term “UE” might refer to devices that have similar capabilities but that are not transportable, such as desktop computers, set-top boxes, or network appliances. The term “UE” can also refer to any hardware or software component that can terminate a communication session for a user. Also, the terms “user equipment,” “UE,” “user agent,” “UA,” “user device,” and “mobile device” might be used synonymously herein.

As telecommunications technology has evolved, more advanced network access equipment has been introduced that can provide services that were not possible previously. This network access equipment might include systems and devices that are improvements of the equivalent equipment in a traditional wireless telecommunications system. Such advanced or next generation equipment may be included in evolving wireless communications standards, such as long-term evolution (LTE). For example, an LTE system might include an Evolved Universal Terrestrial Radio Access Network (E-UTRAN) node B (eNB), a wireless access point, or a similar component rather than a traditional base station. Any such component will be referred to herein as an eNB, but it should be understood that such a component is not necessarily an eNB. Such a component may also be referred to herein as an access node. LTE may be said to correspond to Third Generation Partnership Project (3GPP) Release 8 (Rel-8 or R8), Release 9 (Rel-9 or R9), and Release 10 (Rel-10 or R10), and possibly also to releases beyond Release 10, while LTE Advanced (LTE-A) may be said to correspond to Release 10 and possibly also to releases beyond Release 10. As used herein, the terms “legacy”, “legacy UE”, and the like might refer to signals, UEs, and/or other entities that comply with LTE Release 10 and/or earlier releases but do not comply with releases later than Release 10. The terms “advanced”, “advanced UE”, and the like might refer to signals, UEs, and/or other entities that comply with LTE Release 11 and/or later releases. While the discussion herein deals with LTE systems, the concepts are equally applicable to other wireless systems as well.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of a downlink LTE subframe, according to the prior art.

FIG. 2 is a diagram of an LTE downlink resource grid in the case of a normal cyclic prefix, according to the prior art.

FIG. 3 is a diagram of a mapping of a cell-specific reference signal in a resource block in the case of two antenna ports at an eNB, according to the prior art.

FIG. 4 is a diagram of a resource element group allocation in a resource block in the first slot when two antenna ports are configured at an eNB, according to the prior art.

FIG. 5 is a diagram of an R-PDCCH configuration, according to the prior art.

FIG. 6 is a diagram of different multiplexing schemes for the E-PDCCH region and the PDSCH region, according to an embodiment of the disclosure.

FIG. 7 is a diagram of downlink and uplink grants transmitted in both slots of the E-PDCCH region, according to an embodiment of the disclosure.

FIG. 8 is a diagram of PRB pair-based assignments for the PDCCH, according to an embodiment of the disclosure.

FIG. 9 is a diagram of PRB-based assignments for the E-PDCCH, according to an embodiment of the disclosure.

FIG. 10 is a diagram of an assignment of a plurality of E-PDCCHs for a plurality of UEs over a whole E-PDCCH region, according to an embodiment of the disclosure.

FIG. 11 is a diagram of an E-PDCCH region with both a DMRS and a common reference signal, according to an embodiment of the disclosure.

FIG. 12 is a diagram of E-PDCCH resource allocations, according to an embodiment of the disclosure.

FIG. 13 is a diagram of E-PDCCH and PDSCH transmission on contiguous resource blocks, according to an embodiment of the disclosure.

FIG. 14 is a diagram of an E-PDCCH region allocation for different carriers, according to an embodiment of the disclosure.

FIG. 15 is a diagram of E-PDCCH information broadcasted/multicasted in the legacy PDCCH region, according to an embodiment of the disclosure.

FIG. 16 is a diagram of a UE-specific PDCCH indicator, according to an embodiment of the disclosure.

FIG. 17 is a flow chart of a PDCCH decoding procedure when the E-PDCCH is configured, according to an embodiment of the disclosure.

FIG. 18 is a diagram of DMRS ports 7 and 8 being used for decoding the E-PDCCH with one or two layers, according to an embodiment of the disclosure.

FIG. 19 is a diagram of a DMRS design for decoding the E-PDCCH, according to an embodiment of the disclosure.

FIG. 20 is a diagram of an embedded UE-specific DMRS for the E-PDCCH, according to an embodiment of the disclosure.

FIG. 21 is a diagram of a mixed E-PDCCH and PDSCH transmission, according to an embodiment of the disclosure.

FIG. 22 is a simplified block diagram of an exemplary network element according to one embodiment.

FIG. 23 is a block diagram with an example user equipment capable of being used with the systems and methods in the embodiments described herein.

FIG. 24 illustrates a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents. Embodiments are described herein in the context of an LTE wireless network or system, but can be adapted for other wireless networks or systems.

In an LTE system, physical downlink control channels (PDCCHs) are used to carry downlink (DL) or uplink (UL) data scheduling information, or grants, from an eNB to one or more UEs. The scheduling information may include a resource allocation, a modulation and coding rate (or derived from transport block size), the identity of the intended UE or UEs, and other information. A PDCCH could be intended for a single UE, multiple UEs or all UEs in a cell, depending on the nature and content of the scheduled data. A broadcast PDCCH is used to carry scheduling information for a physical downlink shared channel (PDSCH) that is intended to be received by all UEs in a cell, such as a PDSCH carrying system information about the eNB. A multicast PDCCH is intended to be received by a group of UEs in a cell. A unicast PDCCH is used to carry scheduling information for a PDSCH that is intended to be received by only a single UE.

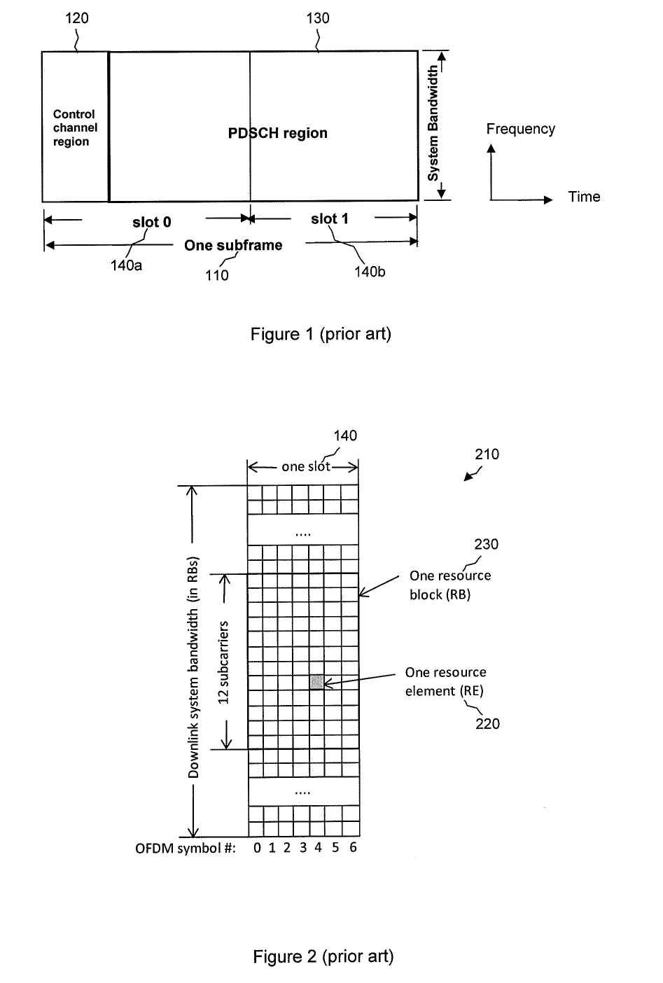

FIG. 1 illustrates a typical DL LTE subframe 110. Control information such as the PCFICH (physical control format indicator channel), PHICH (physical HARQ (hybrid automatic repeat request) indicator channel), and PDCCH are transmitted in a control channel region 120. The control channel region 120 includes the first few OFDM (orthogonal frequency division multiplexing) symbols in the subframe 110. The exact number of OFDM symbols for the control channel region 120 is either dynamically indicated by PCFICH, which is transmitted in the first symbol, or semi-statically configured in the case of carrier aggregation in LTE Rel-10.

The PDSCH, PBCH (physical broadcast channel), PSC/SSC (primary synchronization channel/secondary synchronization channel), and CSI-RS (channel state information reference signal) are transmitted in a PDSCH region 130. DL user data is carried by the PDSCH channels scheduled in the PDSCH region 130. Cell-specific reference signals are transmitted over both the control channel region 120 and the PDSCH region 130, as described in more detail below.

Each subframe 110 can include a number of OFDM symbols in the time domain and a number of subcarriers in the frequency domain. An OFDM symbol in time and a subcarrier in frequency together define a resource element (RE). A physical resource block (RB) can be defined as, for example, 12 consecutive subcarriers in the frequency domain and all the OFDM symbols in a slot in the time domain. An RB pair with the same RB index in slot 0 (140a) and slot 1 (140b) in a subframe can be allocated together.

FIG. 2 shows an LTE DL resource grid 210 within each slot 140 in the case of a normal cyclic prefix (CP) configuration. The resource grid 210 is defined for each antenna port, i.e., each antenna port has its own separate resource grid 210. Each element in the resource grid 210 for an antenna port is an RE 220, which is uniquely identified by an index pair of a subcarrier and an OFDM symbol in a slot 140. An RB 230 includes a number of consecutive subcarriers in the frequency domain and a number of consecutive OFDM symbols in the time domain, as shown in the figure. An RB 230 is the minimum unit used for the mapping of certain physical channels to REs 220.

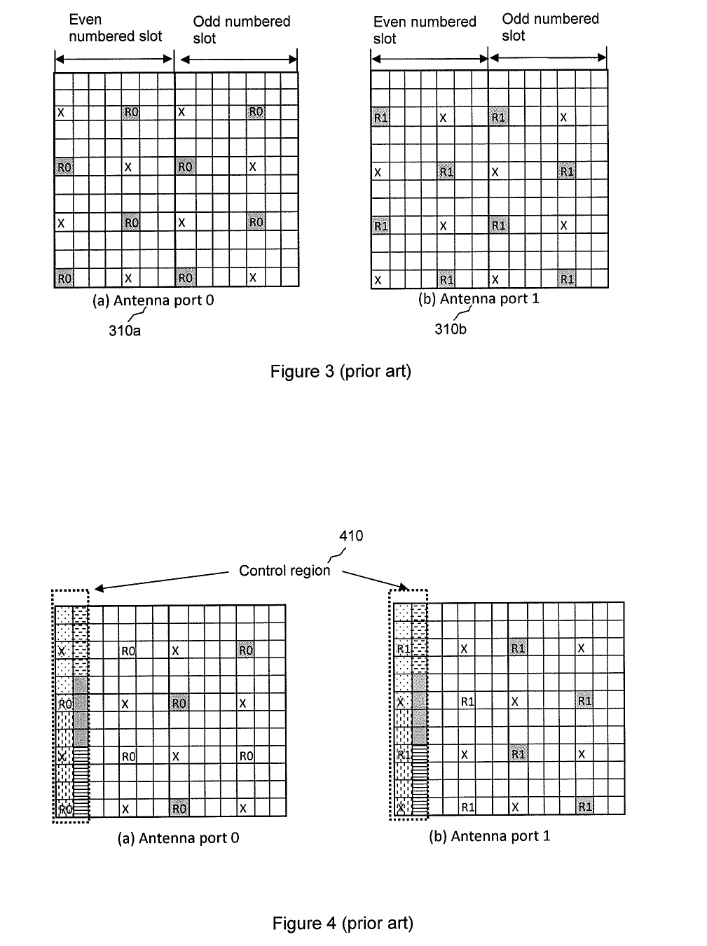

For DL channel estimation and demodulation purposes, cell-specific reference signals (CRSs) can be transmitted over each antenna port on certain pre-defined time and frequency REs in every subframe. CRSs are used by Rel-8 to Rel-10 legacy UEs to demodulate the control channels. FIG. 3 shows an example of CRS locations in a subframe for two antenna ports 310a and 310b, where the RE locations marked with “R0” and “R1” are used for CRS port 0 and CRS port 1 transmission, respectively. REs marked with “X” indicate that nothing should be transmitted on those REs, as CRSs will be transmitted on the other antenna.

Resource element groups (REGs) are used in LTE for defining the mapping of control channels such as the PDCCH to REs. A REG includes either four or six consecutive REs in an OFDM symbol, depending on the number of CRSs configured. For example, for the two-antenna port CRSs shown in FIG. 3, the REG allocation in each RB is shown in FIG. 4, where the control region 410 includes two OFDM symbols and different REGs are indicated with different types of shading. REs marked with “R0”,“R1” or “X” are reserved for other purposes, and therefore only four REs in each REG are available for carrying control channel data.

A PDCCH can be transmitted on an aggregation of one or more consecutive control channel elements (CCEs), where one CCE consists of, for example, nine REGs. The CCEs available for a UE's PDCCH transmission are numbered from 0 to n_{CCE}−1. In LTE, multiple formats are supported for the PDCCH as shown in Table 1.

TABLE 1

| PDCCH | Number of | Number of resource- | Number of |
|---|---|---|---|
| format | CCEs | element groups | PDCCH bits |
| 0 | 1 | 9 | 72 |
| 1 | 2 | 18 | 144 |
| 2 | 4 | 36 | 288 |
| 3 | 8 | 72 | 576 |

The number of CCEs available in a subframe depends on the system bandwidth and the number of OFDM symbols configured for the control region. For example, in a 10 MHz system with three OFDM symbols configured for the control region and six groups configured for the PHICH, 42 CCEs are available for the PDCCH.

Multiple PDCCHs may be multiplexed in the control region in a subframe to support UL and DL data scheduling for one UE and to support DL and UL scheduling for more than one UE. For a given system bandwidth, the number of PDCCHs that can be supported in the control region also depends on the aggregation level used for each PDCCH which, for a given target packet error rate, is determined by the downlink received signal quality at a UE and the size of the downlink control information (DCI) to be carried by a PDCCH. In general, a high aggregation level is needed for a PDCCH intended for a UE that is at the cell edge and is far away from the serving eNB, or when a DCI with a large payload size is used.

The legacy PDCCH region in LTE may have capacity issues for some new applications or deployment scenarios where the number of scheduled UEs in a subframe could be large. Some examples include multiple user multiple input multiple output (MU-MIMO) transmission, coordinated multi-point (CoMP) transmission, heterogeneous network (hetnet) deployment with remote radio heads (RRHs) in a cell sharing the same cell ID, and carrier aggregation (CA). With these deployment scenarios, there may be a need to enhance the capacity of the PDCCH.

The majority of MIMO schemes defined in Rel 8/9/10 apply only to the data channel, the PDSCH. For the downlink control channels there may be limited benefits from the increase in the number of antenna ports in terms of enhancement of capacity. For example, if the DMRS-based MIMO transmission mode 9, defined in Rel-10, is used, PDSCH performance can be improved in scenarios such as MU-MIMO and CoMP. However, there are differences between PDCCH and PDSCH transmissions. The PDCCH transmission adopted in previous releases in LTE uses more robust techniques such as transmit diversity, which focuses more on low error rate and large coverage and therefore may not lead to the same level of enhancement on data throughput as seen by the PDSCH transmission.

Due to increasing traffic demands, non-uniform network deployments (e.g., heterogeneous deployment) may necessitate further optimization and enhancement of the MIMO and CoMP techniques. With these deployment scenarios, it may be necessary to enhance the capacity of the DL control channel. More specifically, in the case of MU-MIMO, with low-power RRHs or a low-cost distributed antenna system, more UEs are able to utilize enhanced MU-MIMO compared to the homogeneous macro deployment. In order to enable more UEs to experience the advanced MIMO techniques in a wide coverage scenario, the capacity of the downlink control channel may need to be increased.

In CoMP scenario 3, as discussed in LTE Rel-11, there may be a heterogeneous network with a low power pico-cell within the macro-cell, where a separate cell ID is used for each cell (macro or pico). In this case, the PDCCH transmitted in the legacy PDCCH region can experience strong interference from other cells. For example, the PDCCH transmitted in the legacy PDCCH region of a pico-cell could experience strong interference from a macro-cell.

In CoMP scenario 4, as discussed in LTE Rel-11, there may be a network with low power nodes (LPNs) such as RRHs within the macro-cell coverage, where the transmission and reception points created by the RRHs share the same cell IDs as the macro-cell. In this case, for backward compatibility, all transmission points may need to transmit the PDCCH in the legacy PDCCH region. Hence, the capacity of the downlink control channel may become a bottleneck to support a large number of users in such a system. Hereinafter, the term “transmission point” (TP) may be used to refer to either an LPN or a macro-eNB.

A carrier aggregation-based heterogeneous network deployment uses cross-carrier scheduling as specified in Rel-10. When cross-carrier scheduling is applied, the PDCCH used for scheduling the PDSCH on the secondary cell is transmitted in the PDCCH region on the primary cell. This may require higher capacity for the PDCCH channel in the primary cell.

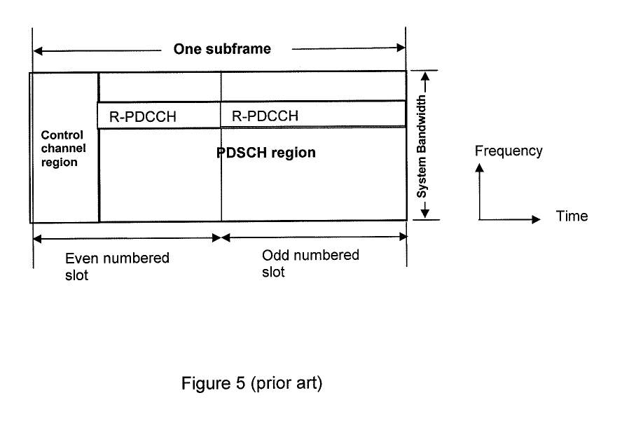

To increase PDCCH capacity, the concept of extending the PDCCH transmission into the PDSCH region has been proposed by reusing some of the design principles for the relay PDCCH (R-PDCCH) in LTE Rel-10. The R-PDCCH serves as the DL control channel from an eNB to a relay node (RN). In R-PDCCH design, RBs in the PDSCH region are reserved for R-PDCCH purposes and each R-PDCCH is transmitted in reserved RBs in the PDSCH region. An example of an R-PDCCH configuration is shown in FIG. 5. An R-PDCCH may transmit from the first slot for DL data scheduling and/or the second slot for UL data scheduling. Multiple R-PDCCHs may be multiplexed either with or without cross interleaving.

While the R-PDCCH may be useful for communication between RNs and the eNB, the R-PDCCH concept may not be suitable for improving or enhancing transmission of the PDCCH under more general circumstances. Among the issues that may need to be addressed to enhance PDCCH transmission in general are improving the overall PDCCH capacity, facilitating the adoption of new coding and modulation schemes such as high order modulation, facilitating interference mitigation, facilitating the use of MIMO transmission, and reducing blind decoding.

In various embodiments, five implementations can be provided to address a number of design aspects for an extended or enhanced PDCCH (E-PDCCH). The implementations may stand alone or may be used in various combinations with one another. In all of the implementations, at least a portion of the legacy PDSCH region is used to transmit downlink control information. One or more regions within the legacy PDSCH region that are used to transmit downlink control information can be referred to as the E-PDCCH region. A channel in the E-PDCCH region can be referred to as an E-PDCCH channel or simply E-PDCCH.

The first implementation deals with the E-PDCCH region for heterogeneous deployment and resource multiplexing in the E-PDCCH region. In this implementation, the uplink grant and the downlink assignment could be spread over all OFDM symbols in a slot in an E-PDCCH region. If both slots are assigned, both the uplink grant and the downlink assignment could be spread over two slots of a subframe. DL assignment and UL grant can be treated the same in terms of resource allocation. There may be no boundary to separate them. In addition, the E-PDCCHs of different UEs can share the same virtual resource block (VRB) pair. In particular, the downlink assignment of a first UE can occupy the first slot, and the uplink assignment of a second UE can occupy the second slot. Further, if CA with cross-carrier scheduling is configured, the downlink assignment and uplink grants for the same UE for different carriers could be transmitted adjacent to each other on the same E-PDCCH region, which could include one or multiple PRBs or PRB pairs, or one or multiple VRBs or VRB pairs. This allows downlink control channels of the same UE to share the same DM-RS and to benefit from frequency selective scheduling as a group, regardless of which carrier the downlink control channel is associated with. Additionally, this may reduce the total number of blind decodings the UE has to perform. In addition, a TP-specific E-PDCCH region may be defined for each TP in a cell sharing the same cell ID. A TP-specific reference signal (RS) can be used for the demodulation of E-PDCCHs in each TP-specific E-PDCCH region. The E-PDCCH regions for different TPs may overlap and be reused if the TPs are geographically well separated. The TP-specific RS could reuse the DM-RS defined in Rel-10 without precoding or with TP-specific precoding.

More specifically, at least two issues may need to be solved in terms of E-PDCCH resource allocation. One is the multiplexing of the E-PDCCH region and the PDSCH region, and the other is the multiplexing of different E-PDCCHs together.

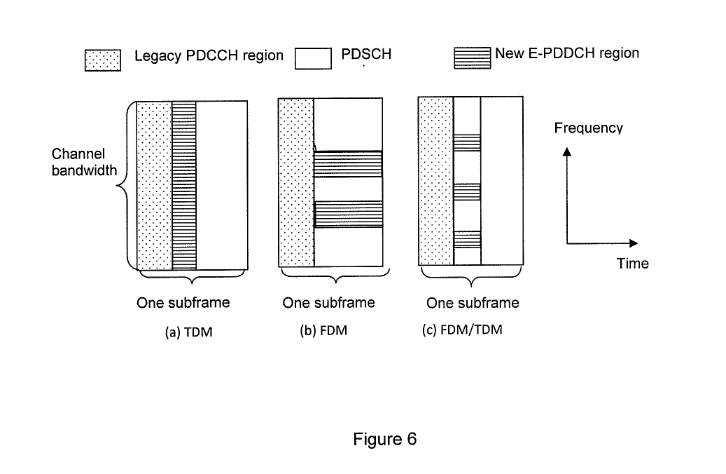

In general, the E-PDCCH region could be multiplexed with the PDSCH region in the legacy PDSCH region with frequency division multiplexing (FDM), time division multiplexing (TDM), or a combination of FDM and TDM. In FDM, the E-PDCCH region and the PDSCH region occupy different resource blocks (PRB pairs). In TDM multiplexing, the E-PDCCH region and the PDSCH region occupy different OFDM symbols. For example, the E-PDCCH region could take the first several OFDM symbols immediately after the legacy PDCCH region, while the PDSCH region could take the rest of the OFDM symbols in the subframe. In the FDM/TDM combination, the E-PDCCH region may occupy several OFDM symbols in certain RBs, while the PDSCH region could occupy the rest of the OFDM symbols in the same RBs. For the remaining RBs where the E-PDCCH region is not configured, the whole subframe could be used for PDSCH transmission. Details of these multiplexing schemes are illustrated in FIG. 6.

There are advantages and disadvantages for each of the multiplexing schemes. The TDM way of multiplexing could allow a UE to detect the PDCCH earlier, and if a PDSCH is scheduled in the same subframe, the UE could also start PDSCH processing earlier. If there is no scheduled PDSCH for the UE, the UE could have the option to turn off part of its receiver for the rest of the subframe to save battery life. A drawback for this way of multiplexing is that one or more OFDM symbols may need to be allocated across the whole operating bandwidth for the E-PDCCH. As legacy UEs are not aware of the existence of such an E-PDCCH allocation, their PDSCH transmission should not be scheduled in the subframe, or a collision could occur between their PDSCH and the E-PDCCH, which could degrade the performance of the PDSCH, as generally, the PDSCH will be punctured.

In the FDM way of multiplexing, resource allocation for the E-PDCCH region can be the same as for the PDSCH region, and thus the presence of the E-PDCCH region can be transparent to legacy UEs. As a consequence, the PDSCHs for both advanced and legacy UEs can coexist in the same subframe. In addition, there is no UE behavior change for PDSCH reception. A drawback is that a UE has to wait until receiving the whole subframe before PDCCH detection. Thus, the processing of the PDSCH could be delayed and the UE receiver may have to be active continuously.

A benefit of the hybrid FDM/TDM approach is similar to that of the TDM approach. That is, a PDCCH can be detected earlier, thus leading to less processing delay and potential power saving at a UE. Similar to the FDM way of multiplexing, a PDSCH of a legacy UE can only be scheduled in the RBs in which no E-PDCCH is transmitted. The PDSCHs for advanced UEs could be scheduled in both types of RBs where the E-PDCCH is configured or not configured. As a result, the PDSCH reception procedure for advanced UEs may need to be modified.

To summarize, the FDM way for multiplexing the E-PDCCH region and the PDSCH region may have less impact for both legacy and advanced UEs and could provide more flexibility for E-PDCCH design. For the FDM or FDM/TDM multiplexing scheme, the E-PDCCH resources allocated in a subframe, either dynamically or semi-statically, could be indicated by a number of VRBs, i.e. {VRB₀, VRB₁, . . . , VRB_{N}_{_{VRB-1}}}, where N_{VRB} is the number of VRBs allocated to the E-PDCCH region.

In 3GPP LTE, two types of virtual resource blocks are defined: virtual resource blocks of a localized type, in which VRB=PRB, and virtual resource blocks of a distributed type, in which a VRB could be mapped to a different PRB in different slots within a subframe. In an embodiment, both localized and distributed VRBs are supported for E-PDCCH resource allocation. For each type of VRB, a pair of VRBs over two slots in a subframe can be assigned together by a single virtual resource block number.

In addition to the above multiplexing between the E-PDCCH region and the PDSCH region on a PRB basis, a remaining issue is whether to assign both slots in a subframe as an E-PDCCH region or to assign only one slot as an E-PDCCH region. For the R-PDCCH, the first slot is used to transmit the downlink grant and the second slot is used to transmit the uplink grant. If there is no uplink grant transmitted in the second slot, the second slot could be used to transmit the PDSCH. However, such a solution has the drawback that if there is no downlink grant transmitted in the first slot, while there is an uplink grant transmitted in the second slot, the first slot resources would be wasted.

The slot-split solution as adopted in R-PDCCH design could work well in the relay backhaul, as there are not many RNs in the cell, and therefore assigning a smaller resource unit to carry the R-PDCCH may be beneficial. For a general E-PDCCH application, the number of advanced UEs would typically be much larger than the number of RNs in the system. In addition, the number of UL and DL grants for UEs in a subframe may not be the same or close. Based on these facts, it may be more beneficial to assign the whole subframe (a PRB or VRB pair occupying both slots) as the E-PDCCH region without splitting the pair into two slots, one for transmitting the downlink grant and the other for transmitting the uplink grant. Another aspect is that the uplink and downlink grants of the same UE could be transmitted separately using the DCI formats defined in previous releases or the current release. The uplink and downlink grants could also be jointly encoded and transmitted in new DCI formats.

In summary, in an embodiment, both uplink and downlink grants are transmitted in both slots in an E-PDCCH region. The uplink and downlink grants from the same UE could be jointly encoded and transmitted in one DCI format.

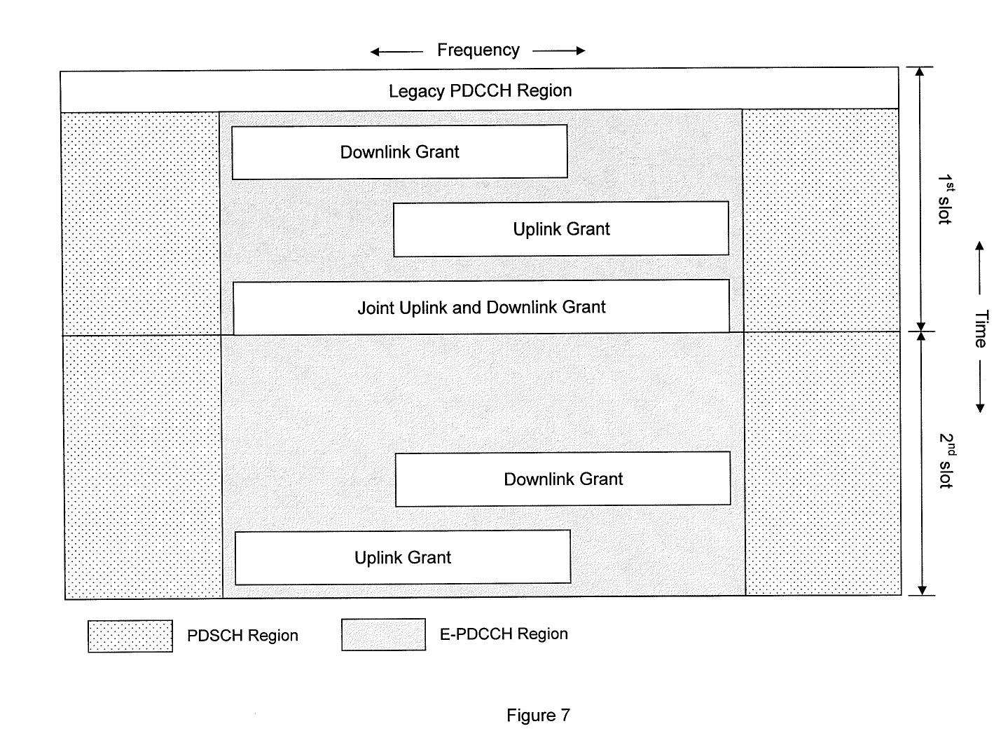

FIG. 7 shows such an example, where for simplicity, the UL and DL grants are multiplexed in a TDM way. Each E-PDCCH can span one or more OFDM symbols. Transmitting the grants in this manner could give more flexibility in assigning resources for the uplink and downlink grants and could balance asymmetric traffic in both the uplink and the downlink. Transmitting the grants in this manner could also be more efficient in resource utilization compared with the slot-split approach for the uplink and downlink grant as adopted in R-PDCCH design, especially when there is asymmetric traffic in the uplink and downlink. Transmitting the grants in this manner could also facilitate the multiplexing of the E-PDCCHs of different users in the E-PDCCH region or both uplink and downlink grants from the same user.

Upon allocation of the E-PDCCH region, the PDCCHs from different users might be multiplexed. In Rel-8/9/10 PDCCH design, the PDCCHs from different users are assigned to different CCEs, and the starting CCE for each UE is related to the UE's radio network temporary identifier (RNTI). After scrambling, modulation, layer mapping, and precoding, the precoded symbols of all the PDCCHs to be transmitted on each antenna port form quadruplet units and are interleaved based on such units before mapping to the corresponding REGs in the legacy PDCCH region. After interleaving, the precoded symbols of a PDCCH are spread over in both time and frequency in the units of REG in the legacy PDCCH region. The interleaving could exploit frequency-time diversity and improve PDCCH performance.

In Rel-10 relay backhaul design, the R-PDCCH can be transmitted with or without interleaving, and such configuration is signaled to the UE on a semi-static basis. In E-PDCCH design, there are several options for multiplexing of E-PDCCHs for different UEs or for the same UE with both uplink and downlink grants. Specifically, resources for E-PDCCH transmission could be assigned on a per-PRB-pair basis or a per-VRB-pair basis. Alternatively, resources for E-PDCCH transmission could be assigned for different carriers of the same UE, and/or E-PDCCHs could be assigned to the entire E-PDCCH region. Each of these options will now be considered in turn.

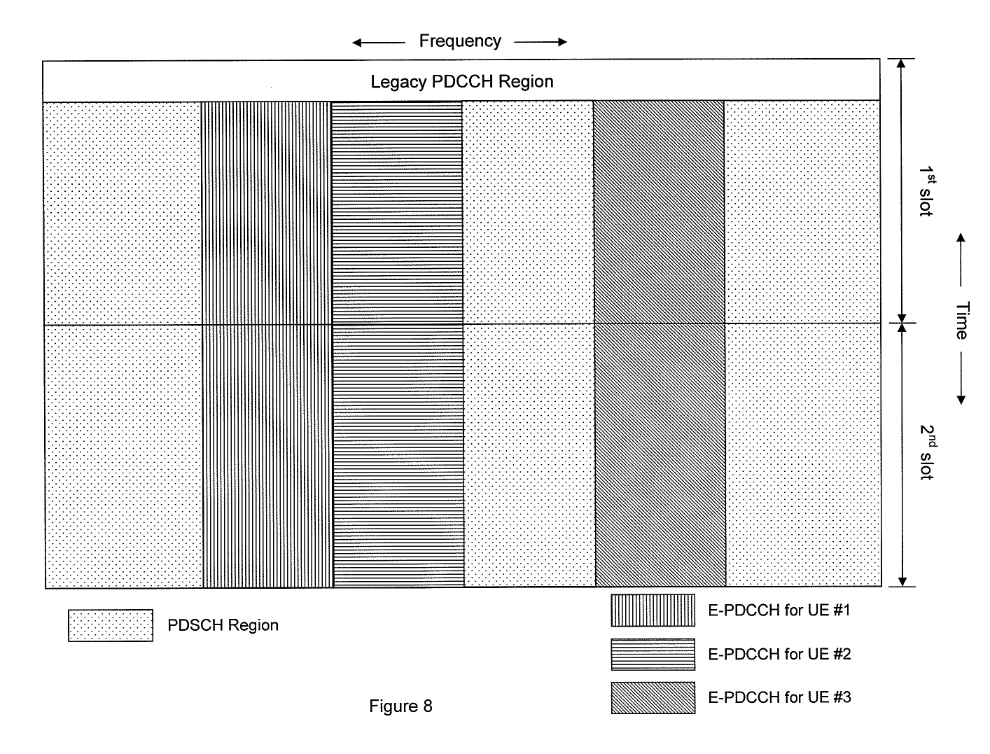

If the DM-RS is used for PDCCH demodulation, it may be preferable to limit the PDCCH of the UE on a same-PRB-pair basis (one RB in frequency and one subframe in time) or in contiguous PRB pairs. This could be applicable to UEs with low mobility and with their DL channel state information (CSI) available at the eNB from, for example, previous CSI feedback. As shown in FIG. 8, the E-PDCCH from different UEs could be allocated with different PRB pairs that would allow the eNB to use different precoding for different UEs for its PDCCH transmission. Assigning PRB pairs to the same UE could also allow the UE to conduct interpolation during channel estimation along the time direction among the DM-RS transmitted in both slots in a subframe. This could improve PDCCH demodulation performance. Within the PRB pair assigned to a particular UE, both downlink and uplink grants could be transmitted. Alternatively, a VRB pair could be assigned to a UE for its E-PDCCH transmission and, in a distributed resource allocation, two RBs in each slot could be transmitted at different frequency locations, thereby benefiting frequency diversity.

The PRB-pair-based assignment does not necessarily mean that one PRB pair could only be assigned to transmit the PDCCH from one UE. For example, if a group of UEs are close to each other in geometry and may benefit from using the same precoding vector for their E-PDCCH transmission, they could be assigned with the same PRB pair for their E-PDCCH transmission, and the same precoding vector could be applied in this PRB pair. Alternatively, E-PDCCHs from a group of UEs could be assigned in the same VRB pair.

In summary, in an embodiment, E-PDCCHs from the same UE are assigned in the same PRB pair or VRB pair. Also, E-PDCCHs from a group of UEs could be assigned in the same PRB pair or VRB pair. E-PDCCHs from different UEs could be assigned with different PRB pairs or VRB pairs.

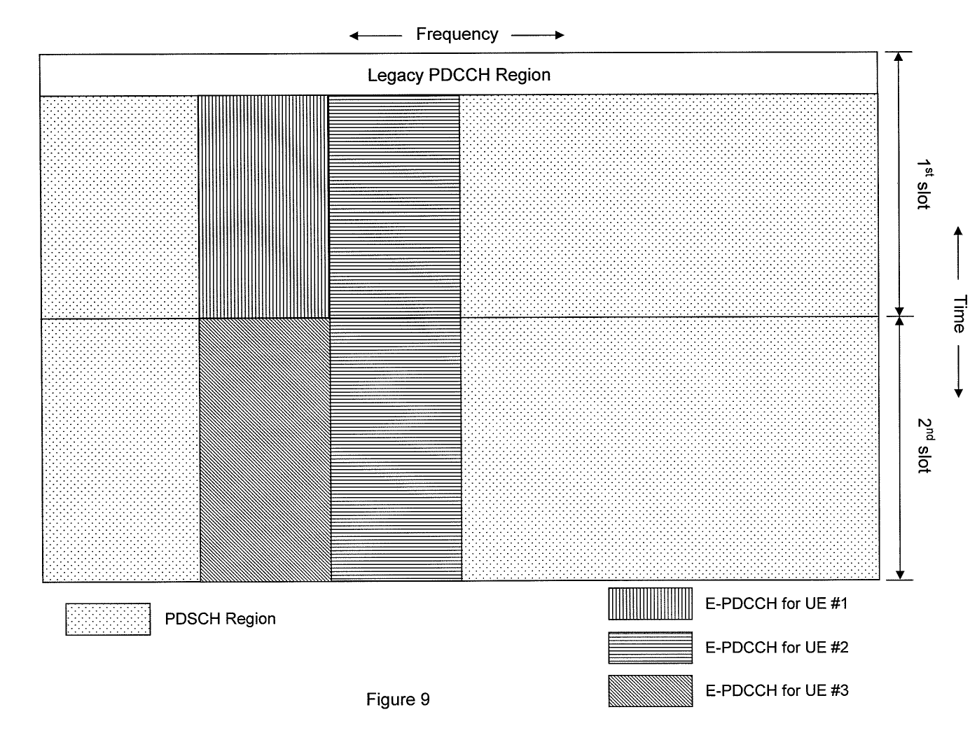

Considering the wide variety of possible downlink control information combinations, there may be cases where the UE is receiving only one E-PDCCH (either downlink assignment or uplink grant). In such a case, there is only one DCI, and the DCI may not be large enough to fill the whole PRB or VRB pair. Thus, it may be beneficial to assign fewer resources to each UE for its E-PDCCH transmission. In that case, it may be more economical to assign an E-PDCCH for each UE on a PRB basis (one PRB in the frequency domain and one slot in the time domain). As shown in FIG. 9, UEs #1 and #3 are assigned with the same PRB in frequency but in different slots. In fact, both PRB-based and PRB-pair-based assignments could be used for the E-PDCCH of each UE, and such assignments can be configured by the eNB. The eNB could either semi-statically or dynamically assign these resource units to the UE based on the payload size of the E-PDCCH. To signal the PRB basis assignment, in addition to the PRB index, one more bit may be needed to signal the slot index.

In summary, in an embodiment, E-PDCCHs from the same UE are assigned in the same PRB. E-PDCCHs from different UEs could be assigned in the same PRB pair but in different slots.

E-PDCCHs from the same UE that are transmitted in the E-PDCCH region could include both uplink and downlink grants scheduled on the same carrier or could include uplink and downlink grants scheduled on different carriers if carrier aggregation (CA) is supported. For example, if a UE is configured to support CA and cross-scheduling is supported, the uplink and downlink grants for multiple carriers for the same UE could all be transmitted on one or a number of PRB/VRB pairs or PRBs assigned to that UE for its E-PDCCH transmission. The grants for the same UE for different carriers could be jointly encoded and transmitted on one E-PDCCH.

In summary, in an embodiment, if CA with cross-carrier scheduling is configured, the downlink and uplink grants for the same UE for different carriers are transmitted together in the same E-PDCCH region, which includes one or multiple PRBs or PRB/VRB pairs. The uplink and downlink grants of the same UE across all carriers could be jointly encoded and transmitted in the same E-PDCCH.

In some situations, it might be beneficial to assign the E-PDCCH of each UE to the whole allocated E-PDCCH region. For example, for a system with RRHs, if a TP-specific reference signal (RS) can be defined and transmitted from each TP, the RSs could be used for the demodulation of E-PDCCHs transmitted from the same RRH. In general, a TP can be a macro point or a pico point. The macro point and the pico point can share the same cell ID (CoMP scenario 4), or they can have different cell IDs (CoMP scenario 3). CoMP scenario 4, where each TP may be allocated a TP-specific frequency region, is assumed in the following discussion of assigning an E-PDCCH to the entire E-PDCCH region.

Also, as used herein, the term “TP-specific” refers to a signal that is transmitted from a transmission point but is not transmitted from other transmission points near that transmission point. Terms such as “near” a TP or “a nearby TP” are used herein to indicate that a UE would have a better DL signal strength or quality if the DL signal is transmitted to that UE from that TP rather than from a different TP.

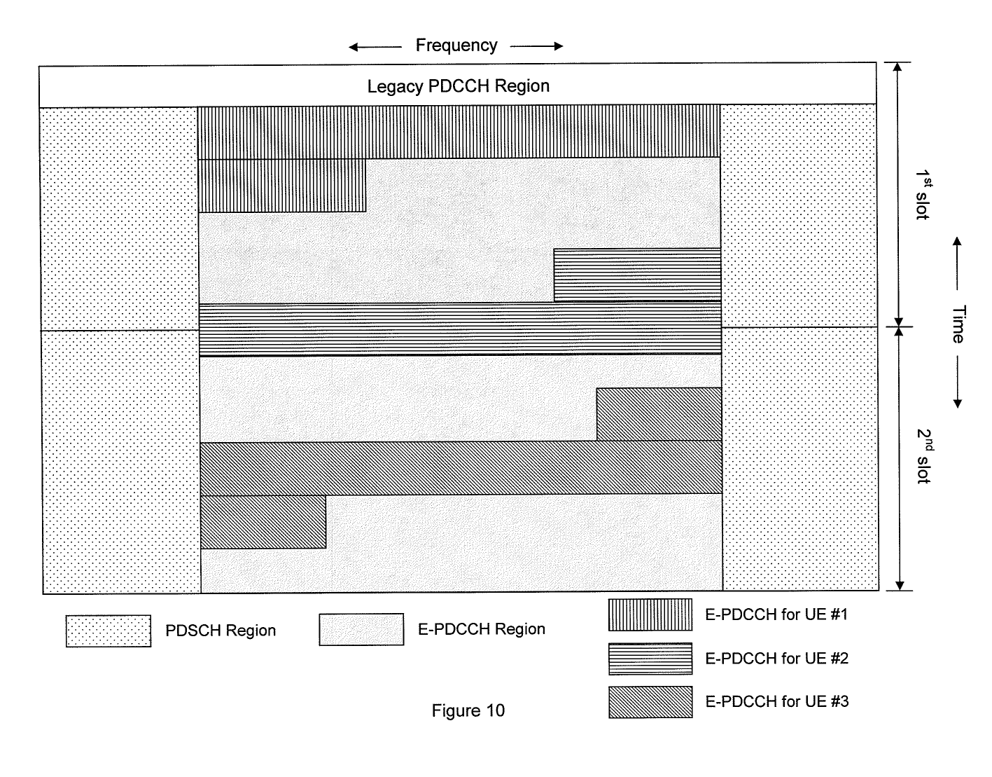

An example is shown in FIG. 10, where E-PDCCHs of three UEs are transmitted over one E-PDCCH region, which may occupy multiple PRB pairs. The resources in an E-PDCCH region could be divided into REGs as is done in the legacy PDCCH region. An E-PDCCH may be allocated with one or multiple CCEs as is done in the legacy PDCCH. The starting CCE of each E-PDCCH could be based on a UE identifier RNTI, similar to the legacy PDCCH case. Interleaving could be conducted on the REG level for all E-PDCCHs. As the E-PDCCH region in general could be smaller than the system bandwidth, the mapping of the E-PDCCH onto the E-PDCCH region could follow the rule of mapping along time first followed by mapping along frequency, similar to the mapping in the legacy PDCCH region. Alternatively, the rule of mapping along frequency first followed by mapping along time could be used. The REG could still be used as the basic E-PDCCH unit in the mapping. FIG. 10 shows an example of mapping along frequency first followed by mapping along time. The mapping shown does not consider the interleaving operation. Different E-PDCCH regions could be allocated for different TPs, and the E-PDCCH transmitted on one E-PDCCH region could be used for the UEs served by the same TP.

In summary, in an embodiment, E-PDCCHs from different UEs are multiplexed and transmitted over an E-PDCCH region. The starting location of each E-PDCCH could be determined by the RNTI. Interleaving could be applied. Either time-frequency or frequency-time mapping of the E-PDCCH to the E-PDCCH region could be used. A TP-specific RS could be used for E-PDCCH demodulation in such an assignment. Different E-PDCCH regions could be assigned for different TPs.

The second implementation related to design aspects for an E-PDCCH deals with E-PDCCH configuration. In this implementation, the DM-RS and the CRS or the TP-specific RS could be configured for PDCCH demodulation in the E-PDCCH region. Such configuration could be linked to other attributes such as localized and distributed resource allocation. Multiple E-PDCCH regions may be defined in a subframe, where E-PDCCHs transmitted in each E-PDCCH region may use a different RS for demodulation (DM-RS, CRS, or TP-specific RS). Since the CRS needs to exist for legacy UEs, three types of RS layout may exist: the CRS only, the DM-RS and the CRS co-existing, or the TP-specific RS and the CRS co-existing. Also, resource allocation, either localized or distributed, could be linked to other configurations such as the use of the DM-RS, CRS, or TP-specific RS for E-PDCCH demodulation. In addition, the E-PDCCH and PDSCH for the same UE could be scheduled together to benefit from frequency selective scheduling.

More specifically, this implementation deals with configuration of E-PDCCH regions with the use of a DM-RS and a TP-specific RS for demodulation, with configuration of E-PDCCH regions with localized and distributed resource allocations, with configuration of the E-PDCCH along with the PDSCH, and with configuration of the E-PDCCH for different carriers.

In E-PDCCH design, it may be beneficial to introduce a UE-specific DM-RS and/or a TP-specific RS for demodulation of the E-PDCCH in order to allow the transmission of the E-PDCCH from any TP deployed in a cell, including RRHs sharing the same cell ID as the macro-eNB. This could also facilitate CoMP transmission. On the other hand, a legacy PDCCH relying only on the CRS for its demodulation might not be optimal for a system with multiple TPs in a cell and sharing the same cell ID. In E-PDCCH design, in contrast with the relay backhaul, a large number of UEs may need to be supported. Therefore, both configurations could be considered at the same time. Namely, in some E-PDCCH regions, a UE-specific DM-RS could be used for E-PDCCH demodulation, while in other E-PDCCH regions, the CRS or a TP-specific RS could be used. Such a configuration could be changed and signaled to the UE semi-statically through high layer signaling or could be pre-defined and broadcast to the UE. Alternatively, such a configuration could be linked to other configurations of the E-PDCCH, such as localized or distributed resource allocation, or with or without cross-interleaving for the E-PDCCH. For example, a UE-specific DM-RS could be used for the demodulation of the E-PDCCH of an individual UE without cross-interleaving, while a TP-specific RS could be used for the demodulation of a plurality of E-PDCCHs for multiple UEs that are cross-interleaved.

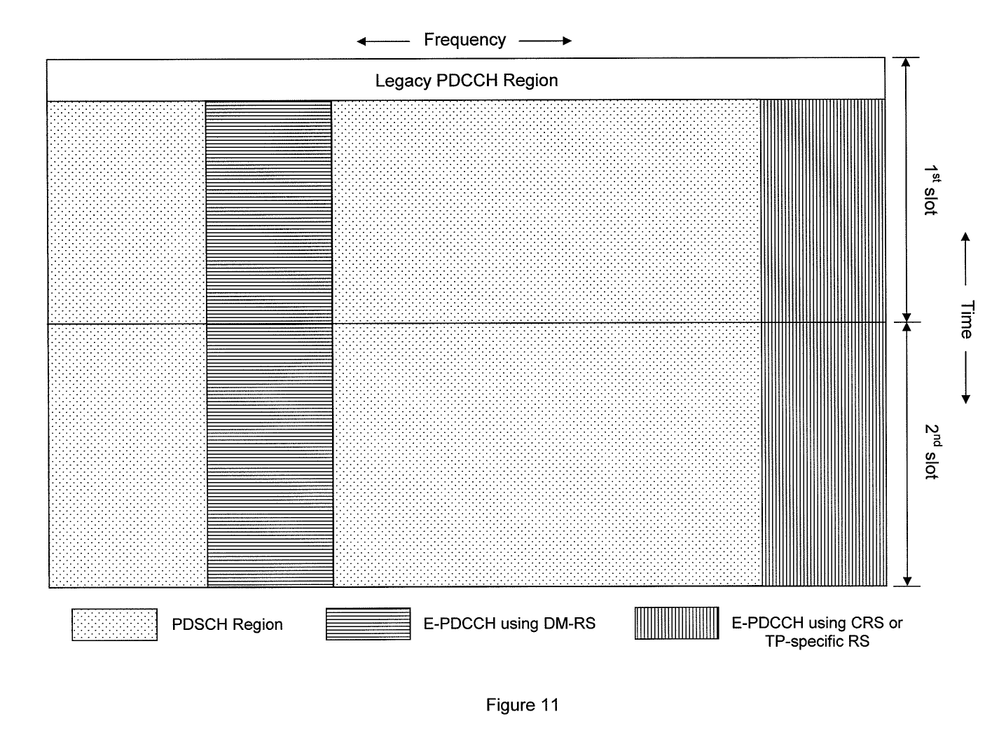

In summary, in an embodiment, the UE-specific DM-RS and either the CRS or a TP-specific RS are configured for E-PDCCH demodulation in the E-PDCCH region. Such a configuration could be linked to other attributes such as localized and distributed resource allocation or the presence or absence of cross-interleaving for the E-PDCCH. An example of such a configuration is shown in FIG. 11.

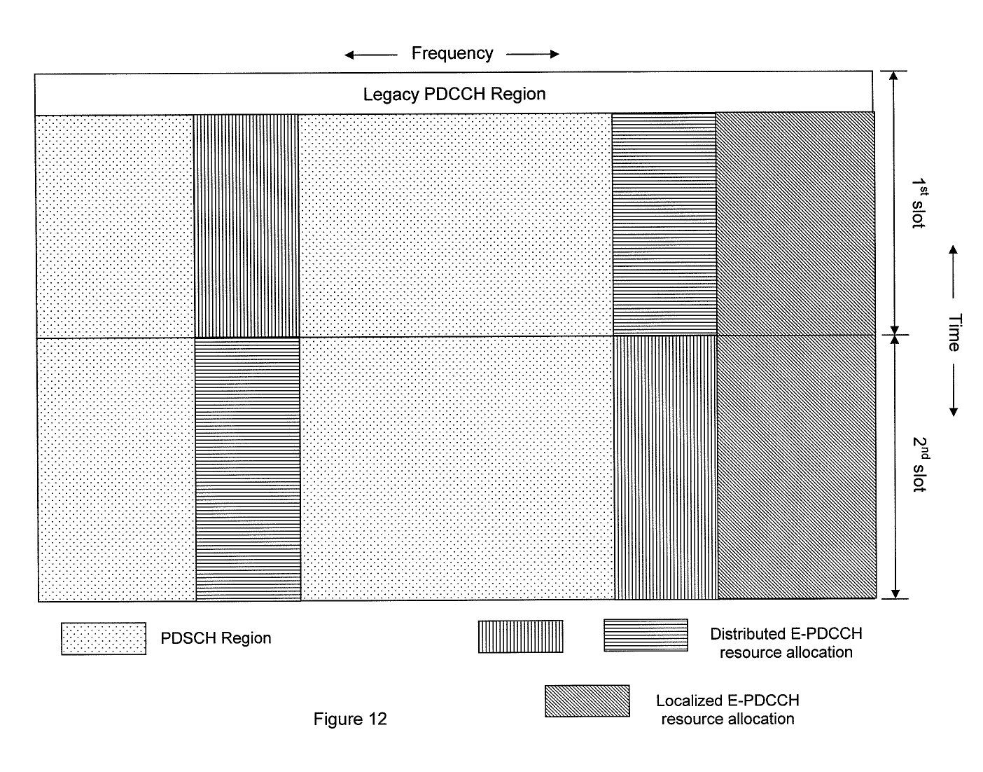

Similar to PDSCH resource allocation, E-PDCCH configuration could include both localized and distributed resource allocation, as shown in FIG. 12. In localized resource allocation, a PRB pair or a group of contiguous PRB pairs could be configured. In distributed resource allocation, a PRB in the second slot could be hopped to another frequency location based on some pre-defined rule. Such a resource configuration could be linked to another type of configuration such as a configuration for a demodulation RS. For example, localized resource allocation could use a UE-specific DM-RS for E-PDCCH demodulation, while distributed resource allocation could use a common RS, such as the CRS or a TP-specific RS, for demodulation.

In summary, in an embodiment, both localized and distributed resource allocations are supported for E-PDCCH resource allocation. Such resource allocation could be linked to other configurations, such as the use of the DM-RS, the CRS, or a TP-specific RS for E-PDCCH demodulation.

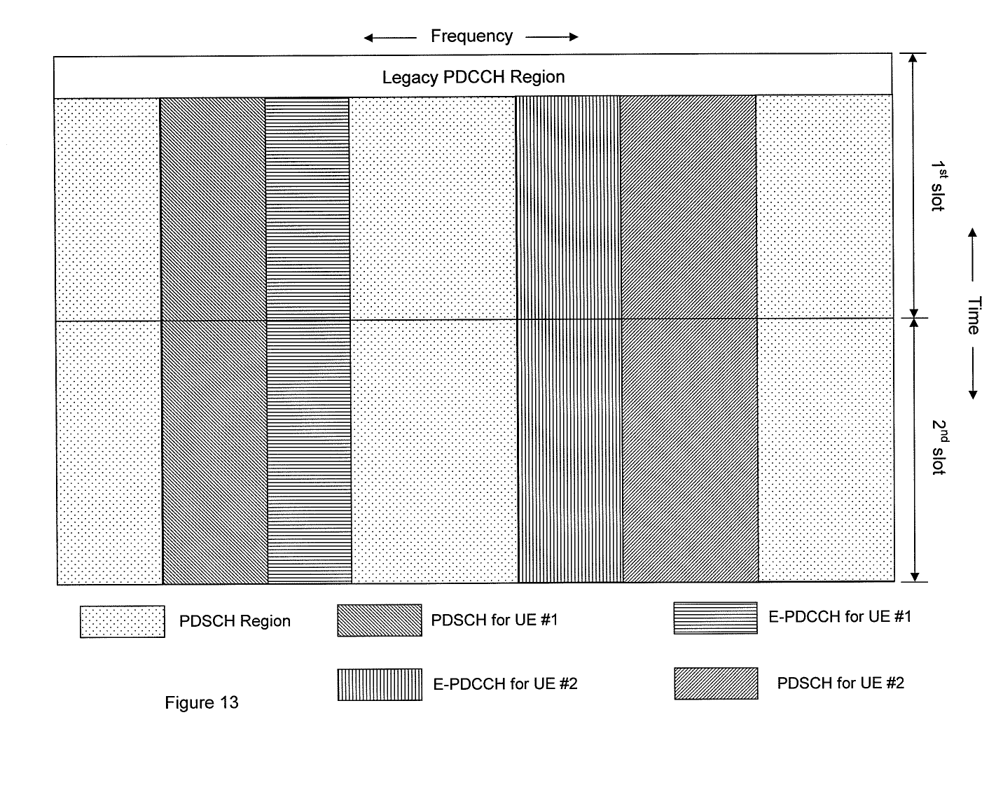

As the E-PDCCH is transmitted in the legacy PDSCH region, some scheduling benefit could be exploited such as frequency selective scheduling. The eNB could have knowledge of the downlink channel based on channel measurement or UE feedback and could schedule both the E-PDCCH and its corresponding PDSCH on certain sub-bands. The E-PDCCH and its corresponding PDSCH could be transmitted on contiguous resource blocks, as shown in FIG. 13.

One way to indicate the location of the E-PDCCH and to limit the number of blind decodings for the UEs is to semi-statically configure a new UE-specific search space. The new search space may include a starting point for each sub-band. Different UEs can have a different search space within each sub-band. The defined search space may be based on the UE's RNTI. The use of this alternate UE search space may be dynamic and may be signaled in the E-PDCCH configuration DCI, which is transmitted in the common search space within the normal PDCCH region.

In summary, in an embodiment, the E-PDCCH and the PDSCH for the same UE are scheduled together to benefit frequency selective scheduling.

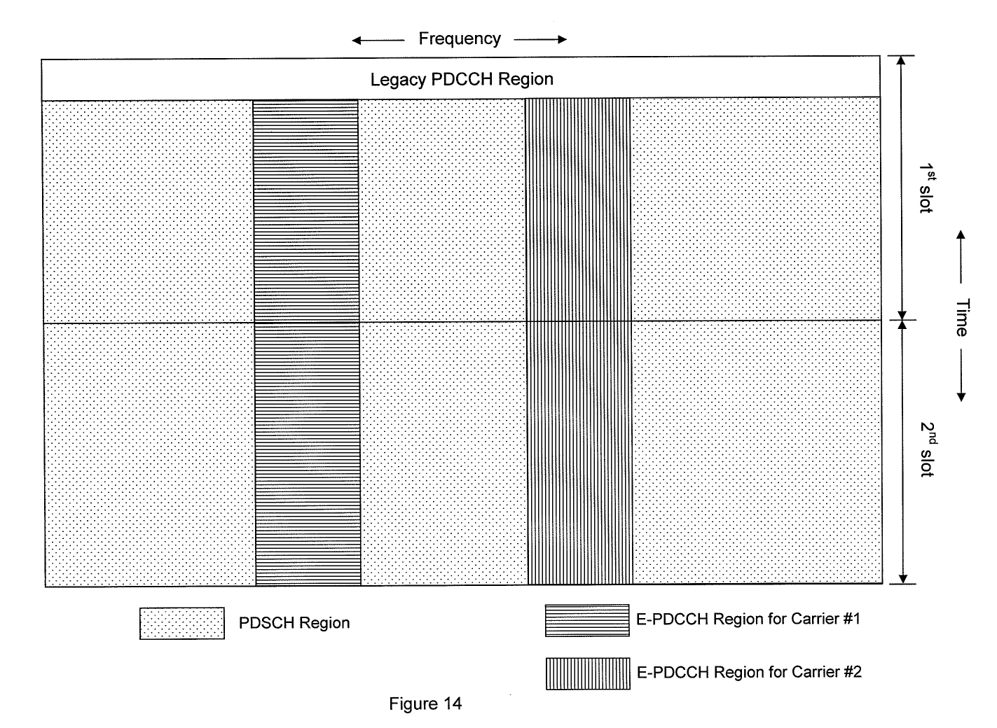

If carrier aggregation is configured, the PDCCHs for different carriers could be transmitted in the E-PDCCH region on the primary carrier if cross-carrier scheduling is configured. The E-PDCCHs of the same UE but for different carriers could be transmitted together, such as in the same PRB pair or PRB. Alternatively, different E-PDCCH regions could be allocated, one for each carrier. In this case, the UEs only decode the E-PDCCH region for the corresponding component carriers that have been activated and configured for cross-carrier scheduling for the UE. FIG. 14 shows one example of such allocation. Such allocation could be configured semi-statically through higher-layer signaling or dynamically through an E-PDCCH indicator transmitted in the legacy PDCCH region.

In summary, in an embodiment, the E-PDCCHs of different carriers of the same UE are transmitted together in one E-PDCCH region. Alternatively, separate E-PDCCH regions could be allocated for each carrier.

The third implementation related to design aspects for an E-PDCCH deals with a decoding procedure with the E-PDCCH. In an embodiment, semi-static signaling is performed for a localized E-PDCCH region configuration. This could include DM-RS and UE-specific control signaling that is precoded to each UE individually. Multiple localized E-PDCCH regions may be configured. The E-PDCCH configuration information for all TPs in a cell or for a group of UEs could be broadcast or multicast semi-statically through higher-layer signaling. The UEs may be individually configured to monitor one or more of the configured regions. The UEs may be assigned a UE-specific search space in each sub-band in order to support frequency selective scheduling for the PDCCH.

Also, dynamic selection might be made from a set of pre-configured E-PDCCH regions. A set of E-PDCCH configurations for a group of UEs could be broadcast or multicast semi-statically through radio resource control (RRC) signaling. The presence of the localized E-PDCCH regions containing resources in each subframe could be indicated dynamically through a new DCI. In general, the new DCI may contain a few bits that could be used to identify which of the configured E-PDCCH regions are present. The new DCI with a pre-defined group RNTI could be transmitted in the common search space in the legacy PDCCH region or in fixed CCEs in the legacy PDCCH region, which could be pre-defined or signaled, or in the UE-specific search space with the location based on the group RNTI.

In addition, there could be a semi-persistent E-PDCCH region configuration. The E-PDCCH configuration could also be broadcast or multicast semi-persistently by using a new DCI transmitted in the legacy PDCCH region. A UE may assume the previous E-PDCCH configuration until the UE receives a new updated E-PDCCH configuration. Alternatively, a UE may assume the E-PDCCH configuration conveyed by the new DCI in a number of contiguous subframes, where such a number of contiguous subframes may be pre-configured through RRC signaling.

Further, there could be a dynamic E-PDCCH region configuration. A UE-specific E-PDCCH indicator including E-PDCCH configuration information could be transmitted in the UE-specific search space in the legacy PDCCH region using a new DCI format, which could point to the E-PDCCH assignment in a localized/distributed E-PDCCH region as well as some attributes of the PDCCH.

In addition, to reduce the maximum number of blind decodings in the E-PDCCH region, some restrictions could be specified for the E-PDCCH transmitted in an E-PDCCH region, with limitations on DCI formats, CCE aggregation level, and/or transmission mode. The restrictions could be configured semi-statically.

More specifically, the E-PDCCH is a new feature in LTE and therefore will be recognized only by advanced UEs, such as those in Rel-11 or beyond. This third implementation provides procedures for an advanced UE to recognize that there is a new E-PDCCH region in the subframe and to determine if there is an E-PDCCH for that UE in the E-PDCCH region. This information might be provided through a broadcast or multicast of E-PDCCH configuration information or through a UE-specific E-PDCCH indicator transmitted in the legacy PDCCH region.

As the E-PDCCH is not supported by legacy UEs, the legacy PDCCH region can still be configured and used to transmit the legacy PDCCH for legacy UEs. Even though an advanced UE could support a new E-PDCCH design, an advanced UE would still support the legacy PDCCH as required for backward compatibility. It may therefore be convenient to use the legacy PDCCH region as the starting point for an advanced UE to look for the new E-PDCCH region information and also to use some legacy DCI formats as the fall-back PDCCH scheme.

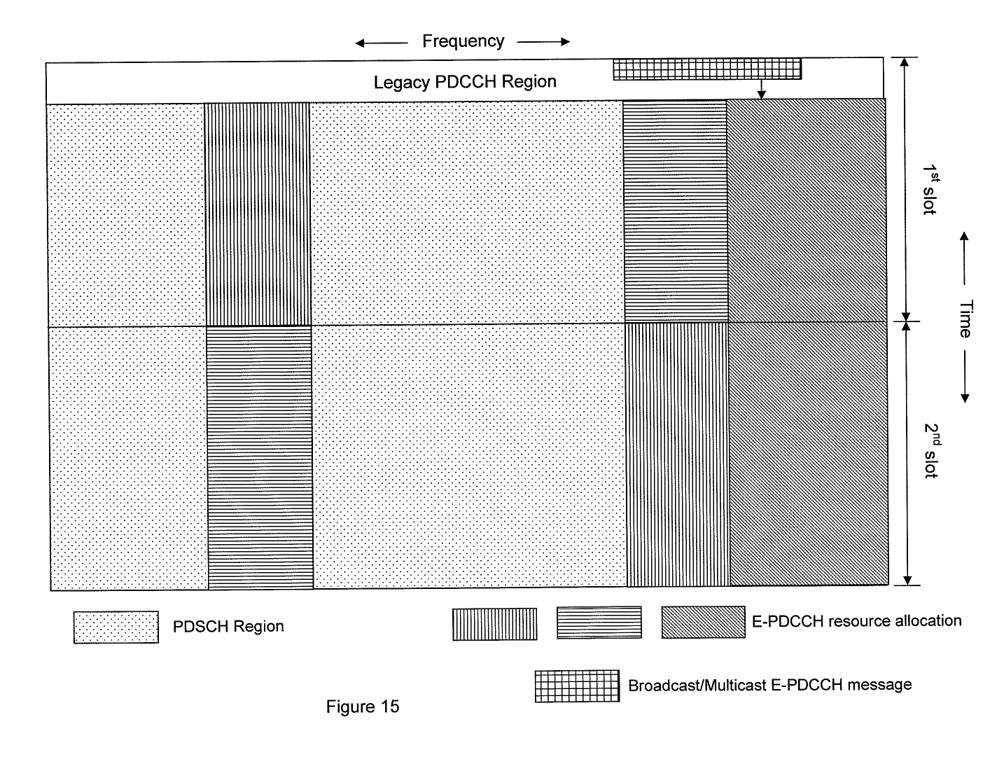

One alternative is to signal the new E-PDCCH region configuration to the new UEs in the common search space in the legacy PDCCH region, as shown in FIG. 15. The broadcast/multicast message could be transmitted in a new DCI format, which might be scrambled by a group RNTI and recognized only by advanced UEs. Advanced UEs could search in the common search space of the legacy PDCCH region for such DCI. After decoding such a message, an advanced UE would know where to find the E-PDCCH region and could decode the E-PDCCH transmitted there. In addition to the locations and new E-PDCCH region information, other attributes of the E-PDCCH may be conveyed as well in such a broadcast/multicast message, such as modulation order, power level, etc.

Another alternative is that this E-PDCCH configuration message could be transmitted in a fixed CCE location in the legacy PDCCH, similar to the PCFICH. The location may be defined in the specifications or may be cell-specific. The location may be signaled to the UEs explicitly, for example in the system information block (SIB). Alternatively, the location may be signaled to the UEs implicitly, for example by a UE deriving the location from the cell ID. Only advanced UEs will decode the E-PDCCH configuration message. The configuration message may contain a bitmap that indicates the presence of pre-configured E-PDCCH regions, where the length of the bitmap is the number of configured E-PDCCH regions.

Advanced UEs could be grouped and assigned with a different group RNTI. For each group of UEs, a broadcast/multicast message about their E-PDCCH configuration could be conveyed in the legacy PDCCH region. In the case of CoMP, the grouping can be naturally defined per RRH so that UEs attached to the same RRH are grouped together. Alternatively, the E-PDCCH configuration information could be signaled semi-statically to the group of UEs through a higher-layer message, such as SIB or RRC signaling. In general, some E-PDCCH configuration attributes may be signaled semi-statically through RRC signaling, while others are signaled dynamically in the new DCI.

To reduce overhead, such E-PDCCH configuration information could be transmitted semi-persistently in the legacy PDCCH region similar to the DCI transmission for a semi-persistent scheduling (SPS) transmission. A UE could assume the E-PDCCH configuration after decoding such an E-PDCCH message and could assume such a configuration until the UE decodes the next broadcast/multicast E-PDCCH configuration message.

In summary, in an embodiment, the E-PDCCH information of a group of UEs is provided in a broadcast/multicast message sent semi-statically through higher-layer signaling or dynamically through a broadcast/multicast message in the common search space in the legacy PDCCH region. The information could also be transmitted in a fixed location in the legacy PDCCH region, which could be pre-defined or signaled. The information could also be transmitted in a broadcast/multicast message that is sent semi-persistently in the legacy PDCCH region. An E-PDCCH indicator DCI may be located in a fixed CCE location similar to the case with the PCFICH. The location may be defined in the specifications or may be cell-specific and signaled to the UEs explicitly (e.g., in the SIB) or implicitly (e.g., through cell ID). Only advanced UEs will decode the E-PDCCH indicator DCI. The indicator may be a bitmap that indicates the presence of pre-configured E-PDCCH regions, where the length of the bitmap is the number of configured E-PDCCH regions.

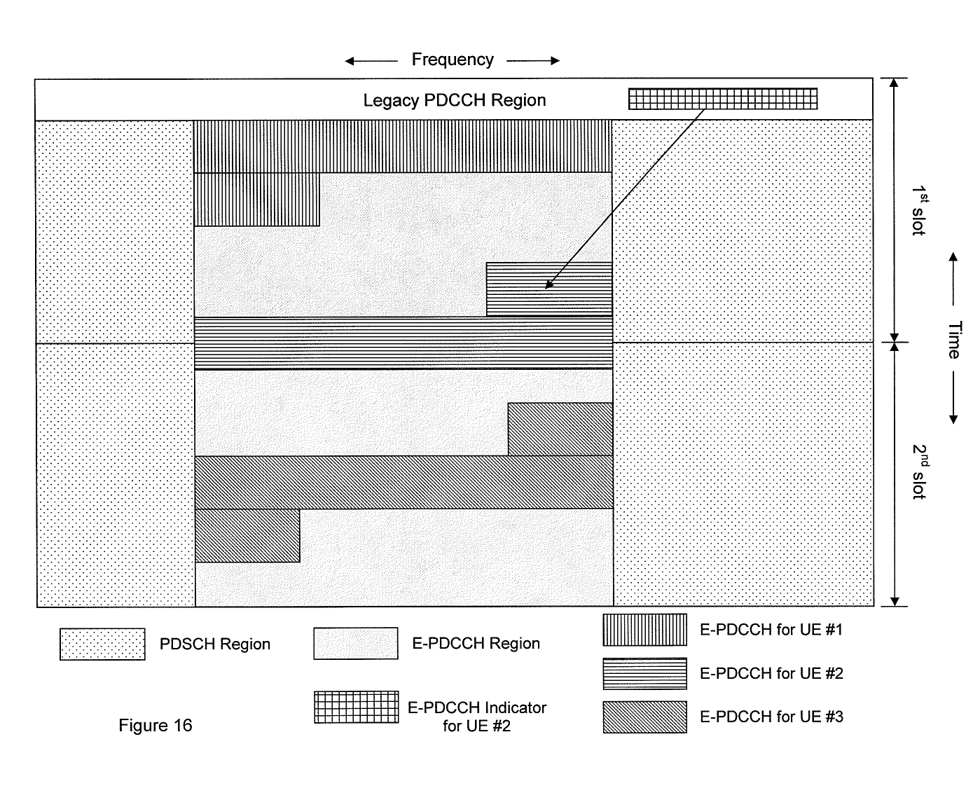

Alternatively, one or more new DCI formats could be introduced which contain information about the E-PDCCH transmitted in an E-PDCCH region. The information could be called the E-PDCCH indicator, as shown in FIG. 16. Such information may not contain the content of the E-PDCCH itself, but could include attributes of the E-PDCCH such as the locations of the E-PDCCH assignment in the new E-PDCCH region, the modulation order, and the resources allocated to the E-PDCCH in terms of REs or CCEs. This new DCI could be scrambled by the RNTI assigned to a particular UE and transmitted the same way as the Rel-8 legacy PDCCH in the legacy PDCCH region. After decoding such a DCI format in a manner similar to the decoding of the Rel-8 legacy PDCCH, an advanced UE could know where to find its real PDCCH in the E-PDCCH region and could decode it. Including some attributes of the E-PDCCH in the E-PDCCH indicator can reduce the blind decoding of the E-PDCCH in an E-PDCCH region and avoid an increase in UE complexity due to the introduction of the E-PDCCH.

As an example, the content of such an E-PDCCH indicator with an estimated number of bits is shown in Table 2, which may contain information including resource allocation, DCI format, modulation and coding scheme (MCS) level, resources needed to carry the E-PDCCH, rank, and DM-RS ports.

TABLE 2

| | | | | Resource | | | | | |
|---|---|---|---|---|---|---|---|---|---|
| UE-specific | | | | length | | | DM-RS | | |
| E-PDCCH | Resource | DCI | | (number | | DM-RS | scrambling | CRC | |
| indicator | location | format | MCS | of CCEs) | Rank | port | ID | bits | Total |
| Number of | X | 1 | 2-3 | 2-3 | 1 | 1 | 1 | 16 | <36 |
| bits | | | | | | | | | |
| (estimated) | | | | | | | | | |

Note:
“X” in Table 2 depends on the manner of resource allocation.

The resource allocation indicates the index of a PRB pair and possibly the slot index (0 or 1). The index of the PRB could be the absolute PRB index with respect to the system bandwidth or could be a relative PRB index with respect to the E-PDCCH region. For example, the E-PDCCH region could be allocated semi-statically, and such an allocation could be broadcast to the UE. The relative PRB index within such an E-PDCCH region for that UE could then be signaled dynamically in the E-PDCCH indicator. Alternatively, a number of E-PDCCH regions may be defined and signaled semi-statically to the UE, and the E-PDCCH indicator may be used to indicate dynamically the allocation of one or more of the pre-defined regions.

The DCI format field could indicate which DCI format will be carried in the E-PDCCH region. One bit could be needed to indicate if the format is DCI format 1A or another DCI format for a corresponding transmission mode (TM). Alternatively, this bit may not be needed if it is pre-defined that DCI format 1A would always be transmitted in the legacy PDCCH region, while the other DCI format (in the corresponding TM) would transmit in the new E-PDCCH region.

The MCS field allows the support of high order modulation for the E-PDCCH in the E-PDCCH region. The MCS level could be a subset of the MCS used for the PDSCH. For example, only quadrature phase shift keying (QPSK) and quadrature amplitude modulation 16 (QAM-16) modulation might be supported in the E-PDCCH.

The resource length field could be used to indicate the number of CCEs instead of REs, such as 1, 2, 4, 8, or 16 CCEs.

Other fields may include the rank, DM-RS port, and DM-RS scrambling ID. The rank field could indicate how many layers could be used to transmit the E-PDCCH, such as one layer or two layers. The DM-RS port field could be used to indicate which layer is used to transmit the E-PDCCH and the corresponding DM-RS ports for its demodulation. The DM-RS scrambling ID could be used to indicate what scrambling seed is used to scramble the RS from the corresponding DM-RS port.

Since this kind of E-PDCCH indicator may need only one or two CCEs to transmit in the legacy PDCCH region, some resources could be released in the legacy PDCCH region and an increase in overall PDCCH capacity might be obtained. On the other hand, as some necessary and important information is conveyed in this new DCI, a large number of blind decodings in the E-PDCCH region could be avoided and an increase in the complexity of the UE could be limited.

To limit the transmission of this E-PDCCH indicator message in the legacy PDCCH region, the message could be sent semi-persistently in the legacy PDCCH similarly to the DCI for SPS transmission. The UE could assume the E-PDCCH configuration after decoding the E-PDCCH and could continue to assume such a configuration until decoding the next E-PDCCH indicator. Such a new DCI format that contains the UE-specific E-PDCCH indicator could be transmitted in the UE-specific search space in the legacy PDCCH region.

In summary, in an embodiment, a UE-specific E-PDCCH indicator is transmitted in a UE-specific search space in the legacy PDCCH region using a new DCI format. The indicator points to the E-PDCCH assignment in the E-PDCCH region as well as some attributes of the E-PDCCH. The indicator could also be transmitted semi-persistently in the legacy PDCCH region.

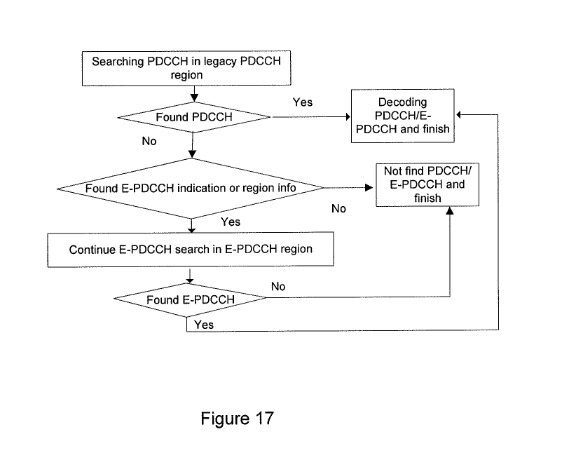

With the introduction of the new E-PDCCH, the PDCCH decoding procedure may need to be modified to support proper PDCCH/E-PDCCH decoding for advanced UEs. As an advanced UE would support the legacy PDCCH as required for backward compatibility, it may be natural for an advanced UE to start PDCCH decoding in the legacy PDCCH region. If the UE can decode the legacy DCI in the legacy PDCCH region, the UE can stop the PDCCH decoding. Otherwise, if the UE decodes a new DCI indicating the new E-PDCCH assignment, the UE may need to decode the E-PDCCH in the new E-PDCCH region. Alternatively, a UE could be configured with search spaces that may be contained within the legacy PDCCH region, the E-PDCCH region, or both. In general, a PDCCH decoding procedure for an advanced UE when the E-PDCCH is configured could be specified as shown in FIG. 17.

This PDCCH/E-PDCCH decoding procedure assumes that the UE needs a dynamic E-PDCCH configuration to indicate where the UE can find its E-PDCCH region. For some scenarios, the E-PDCCH configuration could be semi-statically signaled to the UE or implicitly signaled to the UE. For example, in a system with multiple LPNs or RRHs, the E-PDCCH region could be pre-defined for each LPN or RRH. After UE association with an LPN or RRH is determined, the corresponding E-PDCCH region could be known to the UE, and the UE may not need to start with decoding the PDCCH in the legacy PDCCH region. Parallel decoding can be supported in the legacy PDCCH region and E-PDCCH region.

To simplify the PDCCH/E-PDCCH decoding process, RRC signaling can be used to toggle between the legacy PDCCH region only and the E-PDCCH region only, so that the UE does not need to search for a DL assignment and a UL grant in both regions. It should also be noted that the above decoding flow can be used for decoding of a PDCCH/E-PDCCH that could be transmitted in both the legacy PDCCH and the E-PDCCH. Considering that a UE could receive multiple PDCCHs in a subframe, the same procedure or a portion of the procedure could be repeated for each PDCCH the UE may receive.

In the above PDCCH decoding procedure, an advanced UE may need to fulfill the blind decoding efforts first in the legacy PDCCH region. If the UE cannot find a PDCCH in the legacy PDCCH region but finds the E-PDCCH message or indicator, the UE may need to go to decode the E-PDCCH in the E-PDCCH region. This procedure may increase the total number of blind decodings. In practice, this increase may not be an issue because, if an advanced UE decodes the E-PDCCH message or the UE-specific E-PDCCH indicator, the UE will simply stop decoding the PDCCH in the legacy PDCCH region and turn to the E-PDCCH region to decode the E-PDCCH, thus avoiding unnecessary blind decoding of the PDCCH in the legacy PDCCH region. As the new DCI containing the E-PDCCH configuration message or the UE-specific E-PDCCH indicator typically will not require a large number of CCEs, the number of blind decodings may not be large. On the other hand, if all PDCCHs for the UE are transmitted in the legacy PDCCH region, and no PDCCH is transmitted in the E-PDCCH region, then the E-PDCCH indicator will not be transmitted. To limit the number of blind decodings for decoding such a new DCI, the CCE aggregation level could be limited to one or two. Table 3 illustrates some examples of the maximum number of blind decodings (BD) for advanced UEs compared with legacy UEs.

TABLE 3

| | BDs in | | BDs for new | BDs for |
|---|---|---|---|---|
| | common | BDs for UE- | DCI with | E-PDCCH |
| | search space | specific search | E-PDCCH | (RRC |
| | (legacy) | space (legacy) | indicator | configurable) |
| Legacy UE | 12 | 32 | 0 | 0 |
| New UE1 | 12 | 0 | 1 (with fixed | 16 |
| | | | size and | |
| | | | location) | |
| New UE2 | 12 | 12 (one CCE | 1 | 20 |
| | | only, RRC | | |
| | | configurable) | | |

It may be beneficial to control the maximum number of decodings if RRC signaling is used to configure the different E-PDCCH regions and define the UE search spaces, which may include the legacy PDCCH and/or one or more of the E-PDCCH regions. The maximum number of blind decodings can be controlled by the size of the configured UE search space and by limiting the DCI formats or aggregation levels for different regions. For the E-PDCCH indicator, there is likely only one DCI format to carry the indicator. For the E-PDCCH, the number of blind decodings can be limited since the DCI indicator can provide configuration information for the E-PDCCHs.

In general, it may be beneficial to support all legacy DCI in the E-PDCCH region. But for convenience, such as to reduce blind decoding, it might be preferable to support limited types of legacy DCI formats in the E-PDCCH region. For example, the DCI formats for MIMO transmission, such as DCI formats 2/2A/2B/2C, could be supported in the E-PDCCH region, while DCI formats with a small payload size, such as DCI 0/1A, could be supported only in the legacy PDCCH region.

As an alternative, only certain CCE aggregation levels could be supported in the E-PDCCH, such as CCE aggregation levels 4 and 8. A new CCE aggregation level could be supported in the E-PDCCH to support either legacy DCI or new DCI, such as combined uplink and downlink grants.

As another alternative, the E-PDCCH could be used only for certain transmission modes. For example, only TM 3/4/8/9 could support E-PDCCH transmission in the E-PDCCH, as the payload size of the corresponding DCI formats is relatively large. Such a condition could also be extended to other transmission attributes, such as transmit rank and system bandwidth. For example, only a transmit rank larger than 4 could allow the transmission of the E-PDCCH in the E-PDCCH region, or only a system bandwidth greater than 10 MHz could allow E-PDCCH transmission in the E-PDCCH region.

In another alternative, a number of E-PDCCH regions can be pre-defined, and within each region, only one type of E-PDCCH would be transmitted. The type of E-PDCCH could include, but is not limited to, specific DCI, specific CCE aggregation levels, specific transmission modes, or some combination of these.

In this way, each E-PDCCH region may only require limited blind decoding. The presence of the E-PDCCH region may be dynamically signaled in the normal PDCCH region using a new DCI.

In summary, in an embodiment, to reduce the number of blind decodings in the E-PDCCH region, some restrictions could be specified for the E-PDCCH transmitted in an E-PDCCH region, with a limitation on DCI formats, CCE aggregation level, transmission mode, etc. Such restrictions could be configured semi-statically.

In one embodiment, DCI format 1A, which is used to schedule a fall-back scheme for each transmission mode, could be transmitted in the legacy PDCCH region only. Alternatively, DCI format 1A for scheduling a fall-back scheme could be transmitted in the legacy PDCCH region or the E-PDCCH region.

The fourth implementation related to design aspects for an E-PDCCH deals with PDCCH transmission in the E-PDCCH region. In an embodiment, a new DM-RS pattern is provided for the E-PDCCH, in contrast to the DM-RS for the PDSCH. A new slot-wise DM-RS design is provided for the PDCCH in the E-PDCCH region, and the DM-RS could be transmitted in the middle of the slot (e.g., OFDM symbol 3-5). The DM-RS could be FDM/CDM/TDM for different layers. A maximum of two DM-RS ports could be specified for E-PDCCH transmission in Rel-11. Two scrambling sequences could be considered to modulate the DM-RS port. Also, a UE-specific embedded DM-RS could be transmitted along with the E-PDCCH for the same UE or a group of UEs. The same precoding could be applied to the UE-specific embedded DM-RS and corresponding E-PDCCH. In addition, a TP-specific RS using a non-precoded DM-RS could be defined. Further, an E-PDCCH transmission could have multiple spatial layers. SU-MIMO could be supported for an E-PDCCH transmission in the E-PDCCH region. The layer index on which the E-PDCCH is transmitted could be fixed or signaled to the UE. The rank could be signaled to the UE if all layers are used for E-PDCCH transmission. Also, MU-MIMO could be supported for E-PDCCH transmission in the E-PDCCH region. The DM-RS port and scrambling ID that the UE uses for E-PDCCH demodulation could be signaled to the UE semi-statically, dynamically, or with a combination of semi-static and dynamic signaling. In addition, an E-PDCCH and PDSCH from the same UE could be multiplexed and transmitted on the same resources but on different layers. The E-PDCCH could be transmitted on a pre-defined layer.

More specifically, the new E-PDCCH region allows a completely new design for the E-PDCCH and therefore could satisfy different needs and requirements. It is well known that MIMO transmission is important in LTE for increasing the PDSCH capacity. For the legacy PDCCH, due to considerations of robustness being the first priority in Rel-8, no MIMO transmission for the PDCCH is supported. The lack of support for MIMO transmission for the legacy PDCCH is also due to the difficulty in signaling prior information to the UE for PDCCH decoding, since MIMO transmission requires more attributes. However, with the E-PDCCH, prior information for the E-PDCCH may not be considered an issue, mainly because of two reasons. First, the E-PDCCH could be used for selected UEs that experience good channel conditions, such as richness of scattered channels and a high signal to noise ratio. Second, as the legacy PDCCH is already supported, the DCI transmitted in the legacy PDCCH region could be used to convey some prior information for the E-PDCCH transmitted in the E-PDCCH region, and therefore could allow more complicated E-PDCCH transmissions.

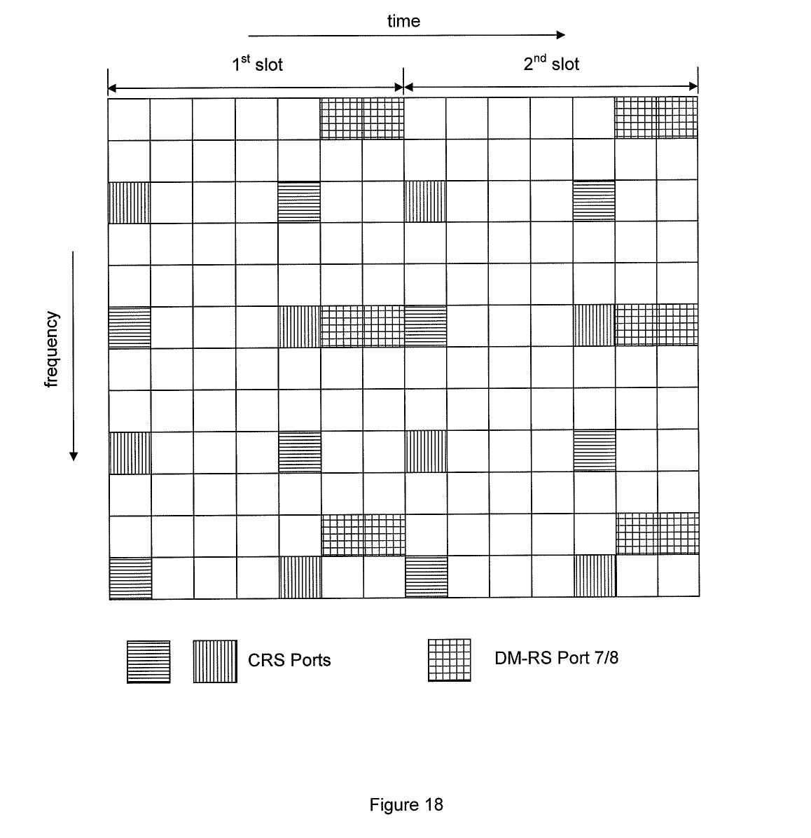

As mentioned above, a benefit of introducing the E-PDCCH is the capability of using the DM-RS for E-PDCCH demodulation, which could facilitate transmission of the E-PDCCH in the RRH and CoMP scenarios. DM-RS ports 7 and 8, designed in Rel-9/10 for the PDSCH, could be reused, as shown in FIG. 18, to decode the E-PDCCH with one or two layers for a single UE or one layer for each UE in MU-MIMO transmission. Using such a DM-RS can provide good performance when the whole subframe (a PRB pair) is allocated as a resource unit for E-PDCCH transmission, as the DM-RS in two slots could be interpolated in time to improve the channel estimation performance, especially for UEs with some mobility.

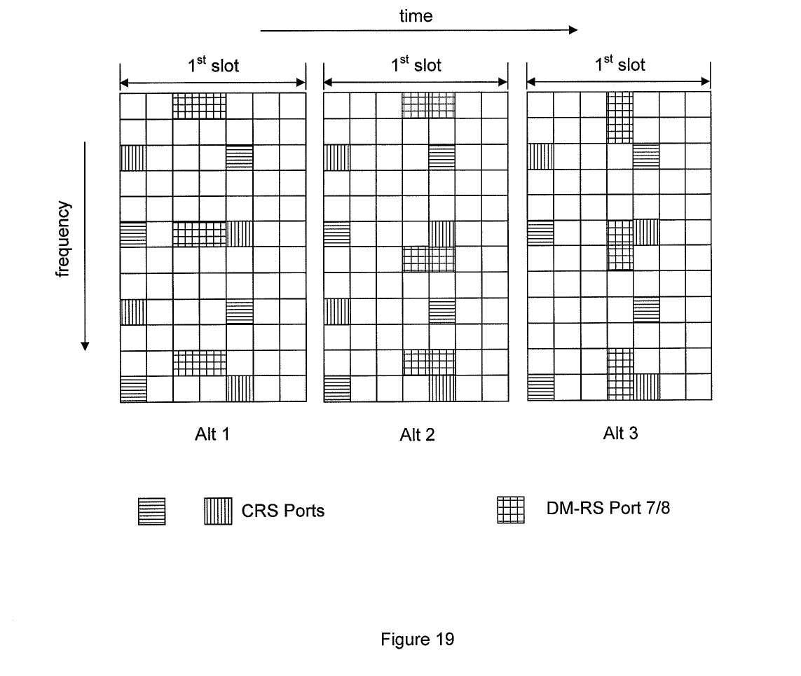

In the situation where an E-PDCCH resource allocation unit is smaller than one PRB pair, such as one PRB (either in slot 0 or slot 1), if E-PDCCH demodulation relied only on the legacy DM-RS transmitted in one slot, channel estimation performance could be degraded. To improve channel estimation performance, the DM-RS could be re-designed for E-PDCCH demodulation in a smaller resource area, such as a slot. FIG. 19 shows some re-design examples of the DM-RS for E-PDCCH transmission, where legacy DM-RS ports 7 and 8 are moved from the edge of the slot to the middle of the slot, thus improving channel estimation performance.

To be more specific, in alternative 1 illustrated in FIG. 19, two DM-RS ports are CDM multiplexed along the time direction and transmitted on OFDM symbols 3 and 4. In alternative 2, two DM-RS ports are CDM multiplexed along the time direction and transmitted on OFDM symbols 4 and 5. In alternative 3, two DM-RS ports are CDM multiplexed along the frequency direction and transmitted on OFDM symbol 4.

In general, the following principles for DM-RS re-design for the PDCCH could be used as guidelines for slot-wise DM-RS design for the demodulation of the E-PDCCH. The DM-RS could be transmitted in the middle (e.g., OFDM symbol 3-5) of the slot. The DM-RS could use FDM/CDM/TDM multiplexed for different layers. A maximum of two DM-RS ports could be specified for E-PDCCH transmission. Two scrambling sequences could be considered to modulate a DM-RS port.

It is preferable that the DM-RS not collide with other existing common channels or signals, as defined in Rel-8 to Rel-10. The eNB may attempt to avoid such collisions through scheduling. Alternatively, it could be specified that, if such collisions occur, the UE should assume that DM-RS transmission needs to be dropped. It may also be specified that E-PDCCH transmission should rate-match around these DM-RS ports.

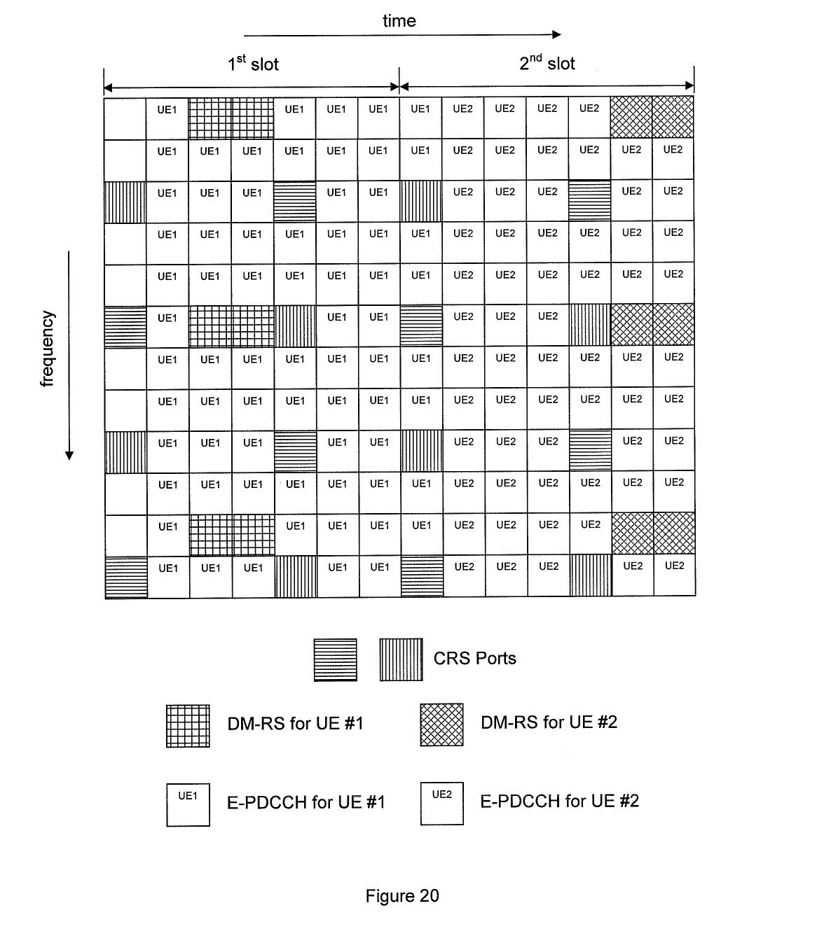

The DM-RS described above might have the same pattern in PRBs if configured. Namely, the location and density of such a DM-RS on a time-frequency resource grid might be fixed and the same for all UEs. As an alternative, a UE-specific embedded DM-RS allocation could be used. A UE-specific embedded DM-RS allocation allows an allocation of resources for the DM-RS along with the E-PDCCH for each particular UE. As shown in FIG. 20, where two UEs have their E-PDCCH transmitted in an E-PDCCH region, along with each E-PDCCH transmission, different UE-specific DM-RSs are also transmitted and are embedded in a corresponding E-PDCCH. Such DM-RSs are not transmitted at fixed locations like the DM-RS described above. For a UE, the same precoding could be applied to its E-PDCCH and its UE-specific embedded DM-RS. For different UEs, different precoding vectors could be applied for precoding the E-PDCCH and corresponding DM-RS. Such a UE-specific embedded DM-RS allocation could allow more flexibility in E-PDCCH resource allocation, as the E-PDCCH of different UEs may no longer need to rely on the same DM-RSs with fixed locations. For example, E-PDCCHs for different UEs can be transmitted in the same PRB or can be multiplexed in the same E-PDCCH region. In this case, as each PDCCH has it own UE-specific embedded DM-RS for its demodulation, different precoding vectors can be used for each E-PDCCH.

The UE-specific DM-RS could be extended into a group-specific DM-RS, where a group of UEs could transmit their E-PDCCHs together along with the group-specific DM-RS. The same precoding could be applied to these E-PDCCHs and their group-specific DM-RS.

In summary, in an embodiment, a UE-specific embedded DM-RS is transmitted along with the E-PDCCH for the same UE or a group of UEs. The same precoding could be applied to the UE-specific embedded DM-RS and the corresponding E-PDCCH.

With the UE-specific DM-RS being used for demodulation, the precoding operation on an E-PDCCH transmission in the E-PDCCH region could be applied transparently to the UE. Namely, the UE does not have to be aware whether precoding is applied or, if precoding is applied, what precoding vector is used on its E-PDCCH. In LTE Rel-10, PRB bundling is introduced to improve channel estimation for the PDSCH. The bundling allows a UE to assume that a number of contiguous PRBs use the same precoding vector, which could allow interpolation among contiguous PRBs to improve channel estimation performance. For E-PDCCH transmission in the E-PDCCH region, the bundling operation may not be as useful for two reasons. First, the E-PDCCH may only need one PRB or PRB pair to transmit. Second, channel knowledge may be limited when an E-PDCCH is transmitted. It may therefore be reasonable to turn off PRB bundling for an E-PDCCH transmitted in the E-PDCCH region. That is, PRB bundling should not be assumed for E-PDCCH demodulation in the E-PDCCH region.

For an E-PDCCH transmitted in the E-PDCCH region, MIMO transmission could be considered. Alternatives for E-PDCCH transmission in MIMO include E-PDCCH transmission in single-user MIMO (SU-MIMO), MU-MIMO E-PDCCH transmission, and mixed E-PDCCH and PDSCH transmission.

For E-PDCCH transmission in SU-MIMO, all MIMO layers can be used to transmit the E-PDCCH for the same user, similar to the SU-MIMO transmission for the PDSCH. As a UE may need to have prior knowledge of how many layers its E-PDCCH is transmitted on, such information may need to be either fixed or signaled to the UE. In a first alternative, the E-PDCCH is transmitted on a fixed layer, and the fixed layer could be semi-statically configured and signaled to the UE through higher-layer signaling, such as RRC. In a second alternative, the E-PDCCH is transmitted on a particular layer, and layer information could be signaled dynamically through signaling such as the E-PDCCH indicator transmitted in the legacy PDCCH region. If a maximum of two layers are used to transmit the E-PDCCH, one bit can be used to indicate the layer index for the E-PDCCH transmission. In a third alternative, the E-PDCCH is transmitted on all layers for a certain rank, and rank information could be signaled dynamically through signaling such as the E-PDCCH indicator transmitted in the legacy PDCCH region. If the maximum rank for E-PDCCH transmission is limited to two, one bit can be used to indicate the rank for the E-PDCCH. In a fourth alternative, the E-PDCCH is transmitted on two layers. One layer is used to transmit the uplink grant and one layer is used to transmit the downlink grant. Which layers transmit the uplink or downlink grant can be pre-defined. In a fifth alternative, the E-PDCCH is transmitted on different layers with different ranks. The UE does not receive the rank and layer information either semi-statically or dynamically, but decodes the PDCCH through blind decoding.

The relation between a layer and a DM-RS port might be fixed and might have a one-to-one mapping. The signaling of the layer indication might be equivalent to the corresponding DM-RS port.

As with the PDSCH, MU-MIMO transmission could be applied to the E-PDCCH as well. Namely, the E-PDCCHs for different UEs could be transmitted on the same E-PDCCH resource. In such a case, different DM-RS ports may be needed for different UEs to demodulate their E-PDCCHs. For each UE, a single layer could be used for its E-PDCCH transmission. In addition, different scrambling sequences could be used to scramble the DM-RS sequences for each DM-RS port, thus leading to improved channel estimation.

The DM-RS ports and scrambling seed that will be used to generate the scrambling sequences may need to be signaled to the UE for the UE to decode its E-PDCCH. One bit may be enough to signal the DM-RS ports (two ports), and one bit could be used to signal a different scrambling ID. Again, there are several alternatives to signal such information. In a first alternative, the DM-RS ports and/or scrambling ID could be semi-statically configured and signaled to the UE through higher-layer signaling, such as RRC. In a second alternative, the DM-RS ports and/or scrambling ID could be dynamically configured and signaled to the UE through the E-PDCCH indicator transmitted in the legacy PDCCH region. In a third alternative, one of the DM-RS ports and scrambling ID could be semi-statically configured and signaled through higher-layer signaling, while the other could be dynamically configured and signaled to the UE through the E-PDCCH indicator transmitted in the legacy PDCCH region. In a fourth alternative, one of the DM-RS ports and scrambling ID could be semi-statically or dynamically configured and signaled to the UE. The UE could conduct blind decoding to decode the E-PDCCH. In a fifth alternative, the DM-RS ports could be semi-statically or dynamically configured and signaled to the UE. The scrambling ID could be pre-defined. In a sixth alternative, the UE does not receive the DM-RS port and scrambling ID information either semi-statically or dynamically and could decode the E-PDCCH though blind decoding.

Regarding mixed E-PDCCH and PDSCH transmission, in one alternative, the E-PDCCH and PDSCH from the same UE could be transmitted on the same resource, but on different layers. For example, the E-PDCCH could be transmitted on a layer with a lower index, such as layer 1, while the PDSCH could be transmitted on layers with a higher index, such as layers greater than 1. After decoding the E-PDCCH on layer 1, the UE could further decode the PDSCH on other layers. To facilitate the decoding, the total rank could be signaled to the UE in the E-PDCCH indicator in the legacy PDCCH region.

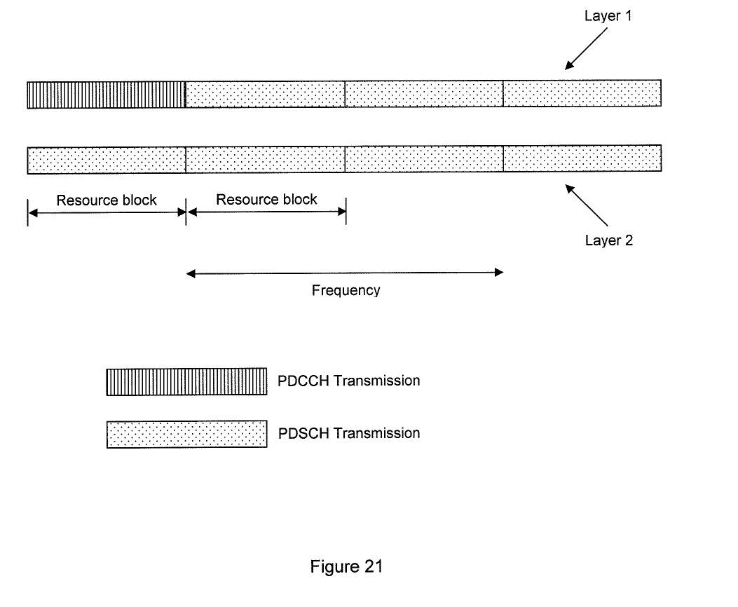

In general, an E-PDCCH transmission requires fewer resources than the PDSCH. Therefore, such a mixed transmission may only occur in a portion of the allocated resource blocks, while the rest of the resource blocks could transmit only the PDSCH, as shown in FIG. 21. In such a case, the UE could decode the first or first several resource blocks for the E-PDCCH at layer 1 and for the PDSCH at layers greater than 1. The decoding of the PDSCH on the rest of the resources, as scheduled by the decoded E-PDCCH, could be the same as SU-MIMO decoding for the PDSCH. The current way of scheduling PDSCH transmission could be used to schedule such a PDSCH transmission. The resource allocations in the downlink grant could indicate the resources used for the layers where there is no E-PDCCH transmission. For the layer where the E-PDCCH is transmitted, the resources used for the PDSCH can be derived by deducting those used for E-PDCCH transmission from the resource allocation for the PDSCH in the grant. As different MCSs are signaled for different layers, the MCS for the layer where the E-PDCCH is transmitted could be adjusted to reflect the missing resources used for the E-PDCCH transmission.

In summary, in an embodiment, an E-PDCCH and a PDSCH from the same UE are transmitted on the same resources but on different layers. The E-PDCCH could be transmitted on a fixed layer.

The fifth implementation related to design aspects for an E-PDCCH deals with a downlink acknowledgement/negative acknowledgement (ACK/NACK) resource indication with the E-PDCCH. That is, in legacy LTE implementations, a PDCCH transmission is typically followed several subframes later by an associated ACK/NACK transmission on the physical uplink control channel (PUCCH) to indicate to the eNB whether the transmission of the PDSCH scheduled by the PDCCH was received successfully by the UE or not.

More specifically, in LTE Rel-8, the resource index defined for a downlink ACK/NACK transmitted on a PUCCH transmission is derived from the lowest CCE index used for the corresponding PDCCH transmission. For example, for a frequency division duplexing (FDD) HARQ-ACK procedure for one configured serving cell, the UE could use PUCCH resource n_{PUCCH}^{(1,p)} for transmission of a HARQ-ACK in subframe n on antenna port p for PUCCH format 1a/1b, where, for a PDSCH transmission indicated by the detection of a corresponding PDCCH in subframe n-4, or for a PDCCH indicating downlink SPS release in subframe n-4, the UE uses n_{PUCCH}^{(1,p=p}^{₀}⁾=n_{CCE}+N_{PUCCH}⁽¹⁾ for antenna port p=p₀, where n_{CCE} is the number of the first CCE (i.e. lowest CCE index used to construct the PDCCH) used for transmission of the corresponding DCI assignment, and N_{PUCCH}⁽¹⁾ is configured by higher layers. For two antenna port transmission, the PUCCH resource for antenna port p=p₁ can be given by n_{PUCCH}^{(1,p=p}^{₁}⁾=n_{CCE}+1+N_{PUCCH}⁽¹⁾.

The above mentioned association may not exist between the E-PDCCH and the PUCCH. That is, with the E-PDCCH, there does not exist a PDCCH that provides the resource index of the ACK/NACK PUCCH. Thus, a new mechanism may need to be defined to provide such an index.

In an embodiment, for a PDCCH transmitted on the k^{th} E-PDCCH region, the corresponding hybrid automatic repeat request ACK (HARQ-ACK) resource for a PUCCH transmitted on the first transmission antenna port at a UE could be derived as follows:

$${n}_{PUCCH}^{( 1 , p = {p}_{0} )} = {n}_{CCE , max} + {\sum }_{m = 1}^{m = k - 1} {n}_{CCE , max}^{( m )} + {n}_{CCE , E - PDCCH}^{( k )} + {N}_{PUCCH}^{( 1 )} \qquad ( Equation 1 a )$$

where n_{CCE,E-PDCCH}^{(k)} is the lowest CCE index used to carry the E-PDCCH for transmission of the corresponding DCI assignment in the k^{th} E-PDCCH region; n_{CCE,max}^{(m)} is the total number of CCEs in the m^{th} E-PDCCH region; and n_{CCE,max} is the highest CCE index in the legacy PDCCH region. The element n_{CCE,max}^{(m)} is included to ensure that the resources for any PDCCH in the legacy region are avoided. The element

$${\sum }_{m = 1}^{m = k - 1} {n}_{CCE , max}^{( m )}$$

allows ordering the PUCCH resource corresponding to each E-PDCCH region. N_{PUCCH}⁽¹⁾ is configured by higher layers.

If a UE-specific E-PDCCH indicator is transmitted in the legacy PDCCH region, the PUCCH resource index formula in the current LTE standards could be used. That is,

n_{PUCCH}^{(p=p}^{₀}⁾=n_{CCE}+N_{PUCCH}⁽¹⁾

n_{PUCCH}^{(p=p}^{₁}⁾=n_{CCE}+1+N_{PUCCH}⁽¹⁾ (Equation 2a)

However, now n_{CCE} is the lowest CCE index of a UE-specific E-PDCCH indicator in the legacy PDCCH region. To the PUCCH, this association with the PDCCH in the legacy region is substituted with the association with the E-PDCCH.

In addition, for a PDCCH transmitted in the E-PDCCH region, the downlink ACK/NACK resource for a PUCCH transmitted on the second antenna port can be the resource index of the PUCCH for the first antenna port+1.

When the downlink control channel is sent via the E-PDCCH, a new rule may need to be defined for n_{PUCCH}^{(1,p)}. One way to define the resource index is to make the index a function of the maximum CCE index in the legacy control region and of the lowest CCE index in the E-PDCCH region:

n_{PUCCH}^{(1,p=p}^{₀}⁾=n_{CCE,max}+n_{CCE,E-PDCCH}+N_{PUCCH}⁽¹⁾ (Equation 3)

where n_{CCE, max} is the maximum CCE index in the legacy control region, and n_{CCE,E-PDCCH} is the lowest CCE index in the E-PDCCH region that has been used to transmit the E-PDCCH for a particular UE on the first antenna port. For the second antenna port, the same rule could be used as defined in Rel-10. For a given bandwidth, n_{CCE, max} can take three different values, each corresponding to a different CFI, where the CFI is the number of OFDM symbols used for the legacy control region.

If there are multiple E-PDCCH regions, the E-PDCCH regions could be placed in a sequence, for example from lower index to higher index. The CCEs from these E-PDCCH regions could be placed in a queue from the E-PDCCH with lower index to higher index. This queue could then be used to generate a corresponding resource for the ACK/NACK in the PUCCH. For example, if n_{CCE,E-PDCCH}^{(k+1)} is the lowest CCE index of an E-PDCCH in the (k+1)^{th} E-PDCCH region, the index of the resource for the corresponding ACK/NACK could be generated as:

$${n}_{PUCCH}^{( 1 , p = {p}_{0} )} = {n}_{CCE , max} + {\sum }_{m = 1}^{m = k} {n}_{CCE , max}^{( m )} + {n}_{CCE , E - PDCCH}^{( k + 1 )} + {N}_{PUCCH}^{( 1 )} \qquad ( Equation 1 b )$$

where n_{CCE,max} is maximum CCE number in the m^{th} E-PDCCH region.

An alternative is that if the UE-specific E-PDCCH indicator as described above is transmitted in the UE-specific search space in the legacy PDCCH, the lowest CCE could be used to derive the resource of the downlink ACK/NACK transmitted on the first antenna port for the PUCCH. Namely, the following formula could be used:

n_{PUCCH}^{(1,p=p}^{₀}⁾=n_{CCE}^{E}+N_{PUCCH}⁽¹⁾ (Equation 2b)

where the n_{CCE}^{E} here is the lowest CCE index of the UE-specific E-PDCCH indicator transmitted in the legacy PDCCH region. For the second antenna port, the same rule could be used as defined in Rel-10.

If MU-MIMO is used to transmit multiple E-PDCCHs on the same resource but on different layers, then the resources of the PUCCH for the ACK/NACK of each UE may need to be different. One solution could be to add an offset on the PUCCH resource index for the first UE to get the PUCCH resource index for the second UE. For example, if the PUCCH index on the first antenna port for the first UE, n_{PUCCH}^{(1,p=p}^{₀}⁾, is generated following the method described above, then the PUCCH index on the first antenna port for the second UE could be n_{PUCCH}^{(1,p=p}^{₀}⁾+k, where k could be 2. If transmit diversity is not configured at the UE for PUCCH transmission, then k could be 1. Alternatively, if the E-PDCCH of each UE in MU-MIMO transmission is indicated by a separate UE-specific E-PDCCH indicator, then the PUCCH resources of the ACK/NACK for each UE could be derived as described above.

In summary, in an embodiment, for an E-PDCCH transmitted in the E-PDCCH region, the downlink ACK/NACK resource for the PUCCH transmitted on the first antenna port is derived by using the lowest CCE index of the E-PDCCH in the E-PDCCH region+the maximum number of CCEs in the legacy PDCCH region+the sum of the maximum number of CCEs in all E-PDCCH regions with a lower index+a high level configured parameter. Alternatively, if a UE-specific E-PDCCH indicator is transmitted in the legacy PDCCH region, the downlink ACK/NACK resource for the PUCCH transmitted on the first antenna port could be derived using the lowest CCE index of the UE-specific E-PDCCH indicator in the legacy PDCCH region+a high level configured parameter. For an E-PDCCH transmitted in the E-PDCCH region, the downlink ACK/NACK resource for a PUCCH transmitted on the second antenna port is the resource index of the PUCCH for the first antenna port+1. For an E-PDCCH transmitted in MU-MIMO, the downlink ACK/NACK resource of the PUCCH for a second UE could be obtained by an offset from the ACK/NACK resource of the PUCCH for a first UE.

Some of the benefits of the implementations described herein can be summarized as follows. The implementations support different, flexible ways of multiplexing in the E-PDCCH, including uplink and downlink grants, PDCCHs from different UEs, and PDCCHs from different carriers. The implementations support different ways of E-PDCCH configuration based on the use of a reference signal for demodulation and localized and distributed multiple carriers. The implementations support different ways of E-PDCCH configuration which include both cell-specific broadcasting/multicasting and a UE-specific indicator. The implementations support different ways of PDCCH transmission, which include using the DM-RS or a TP-specific reference signal, SU-MIMO or MU-MIMO, PDCCH-only MIMO transmission, or PDCCH and PDSCH mixed MIMO transmission. The implementations support ways of generating resources for an ACK/NACK in the uplink PUCCH for a PDCCH transmitted in the E-PDCCH region.

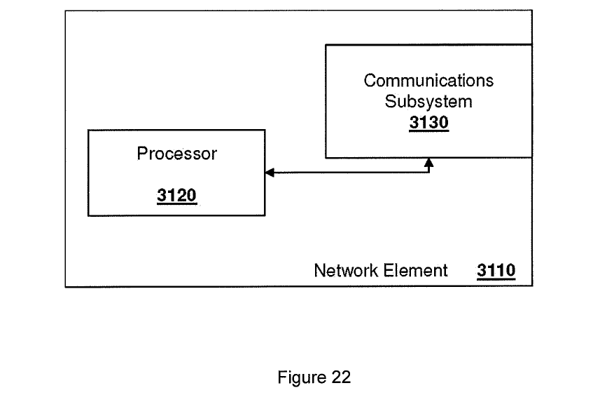

The above may be implemented by any network element. A simplified network element is shown with regard to FIG. 22. In FIG. 22, network element 3110 includes a processor 3120 and a communications subsystem 3130, where the processor 3120 and communications subsystem 3130 cooperate to perform the methods described above.

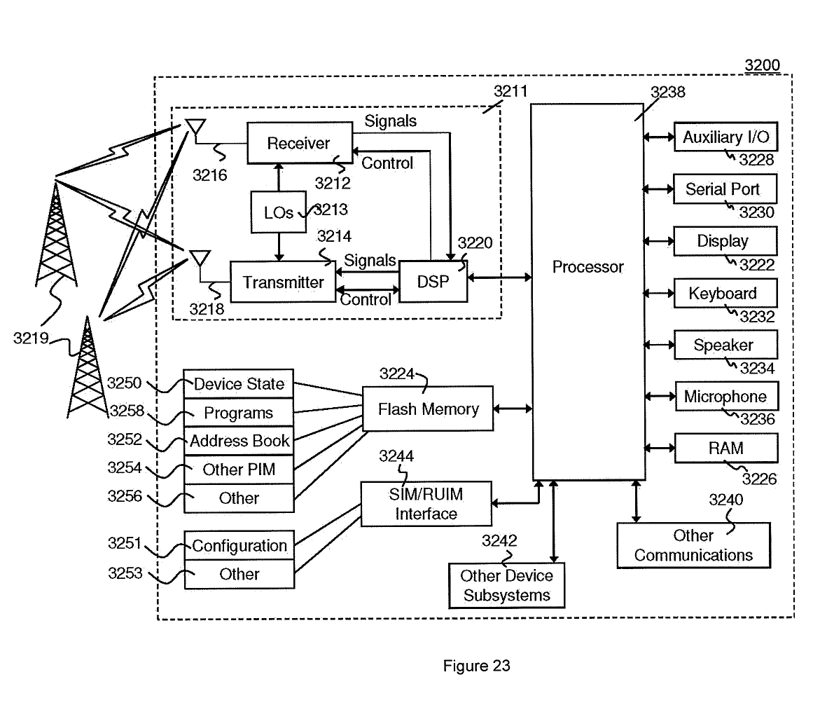

Further, the above may be implemented by any UE. One exemplary device is described below with regard to FIG. 23. UE 3200 is typically a two-way wireless communication device having voice and data communication capabilities. UE 3200 generally has the capability to communicate with other computer systems on the Internet. Depending on the exact functionality provided, the UE may be referred to as a data messaging device, a two-way pager, a wireless e-mail device, a cellular telephone with data messaging capabilities, a wireless Internet appliance, a wireless device, a mobile device, or a data communication device, as examples.

Where UE 3200 is enabled for two-way communication, it may incorporate a communication subsystem 3211, including a receiver 3212 and a transmitter 3214, as well as associated components such as one or more antenna elements 3216 and 3218, local oscillators (LOs) 3213, and a processing module such as a digital signal processor (DSP) 3220. As will be apparent to those skilled in the field of communications, the particular design of the communication subsystem 3211 will be dependent upon the communication network in which the device is intended to operate.

Network access requirements will also vary depending upon the type of network 3219. In some networks network access is associated with a subscriber or user of UE 3200. A UE may require a removable user identity module (RUIM) or a subscriber identity module (SIM) card in order to operate on a network. The SIM/RUIM interface 3244 is normally similar to a card-slot into which a SIM/RUIM card can be inserted and ejected. The SIM/RUIM card can have memory and hold many key configurations 3251, and other information 3253 such as identification, and subscriber related information.

When required network registration or activation procedures have been completed, UE 3200 may send and receive communication signals over the network 3219. As illustrated in FIG. 23, network 3219 can consist of multiple base stations communicating with the UE.

Signals received by antenna 3216 through communication network 3219 are input to receiver 3212, which may perform such common receiver functions as signal amplification, frequency down conversion, filtering, channel selection and the like. Analog to digital (A/D) conversion of a received signal allows more complex communication functions such as demodulation and decoding to be performed in the DSP 3220. In a similar manner, signals to be transmitted are processed, including modulation and encoding for example, by DSP 3220 and input to transmitter 3214 for digital to analog (D/A) conversion, frequency up conversion, filtering, amplification and transmission over the communication network 3219 via antenna 3218. DSP 3220 not only processes communication signals, but also provides for receiver and transmitter control. For example, the gains applied to communication signals in receiver 3212 and transmitter 3214 may be adaptively controlled through automatic gain control algorithms implemented in DSP 3220.

UE 3200 generally includes a processor 3238 which controls the overall operation of the device. Communication functions, including data and voice communications, are performed through communication subsystem 3211. Processor 3238 also interacts with further device subsystems such as the display 3222, flash memory 3224, random access memory (RAM) 3226, auxiliary input/output (I/O) subsystems 3228, serial port 3230, one or more keyboards or keypads 3232, speaker 3234, microphone 3236, other communication subsystem 3240 such as a short-range communications subsystem and any other device subsystems generally designated as 3242. Serial port 3230 could include a USB port or other port known to those in the art.

Some of the subsystems shown in FIG. 23 perform communication-related functions, whereas other subsystems may provide “resident” or on-device functions. Notably, some subsystems, such as keyboard 3232 and display 3222, for example, may be used for both communication-related functions, such as entering a text message for transmission over a communication network, and device-resident functions such as a calculator or task list.

Operating system software used by the processor 3238 may be stored in a persistent store such as flash memory 3224, which may instead be a read-only memory (ROM) or similar storage element (not shown). Those skilled in the art will appreciate that the operating system, specific device applications, or parts thereof, may be temporarily loaded into a volatile memory such as RAM 3226. Received communication signals may also be stored in RAM 3226.

As shown, flash memory 3224 can be segregated into different areas for both computer programs 3258 and program data storage 3250, 3252, 3254 and 3256. These different storage types indicate that each program can allocate a portion of flash memory 3224 for their own data storage requirements. Processor 3238, in addition to its operating system functions, may enable execution of software applications on the UE. A predetermined set of applications that control basic operations, including at least data and voice communication applications for example, will normally be installed on UE 3200 during manufacturing. Other applications could be installed subsequently or dynamically.

Applications and software may be stored on any computer readable storage medium. The computer readable storage medium may be a tangible or in transitory/non-transitory medium such as optical (e.g., CD, DVD, etc.), magnetic (e.g., tape) or other memory known in the art.

One software application may be a personal information manager (PIM) application having the ability to organize and manage data items relating to the user of the UE such as, but not limited to, e-mail, calendar events, voice mails, appointments, and task items. Naturally, one or more memory stores may be available on the UE to facilitate storage of PIM data items. Such PIM application may have the ability to send and receive data items, via the wireless network 3219. Further applications may also be loaded onto the UE 3200 through the network 3219, an auxiliary I/O subsystem 3228, serial port 3230, short-range communications subsystem 3240 or any other suitable subsystem 3242, and installed by a user in the RAM 3226 or a non-volatile store (not shown) for execution by the processor 3238. Such flexibility in application installation increases the functionality of the device and may provide enhanced on-device functions, communication-related functions, or both. For example, secure communication applications may enable electronic commerce functions and other such financial transactions to be performed using the UE 3200.

In a data communication mode, a received signal such as a text message or web page download will be processed by the communication subsystem 3211 and input to the processor 3238, which may further process the received signal for output to the display 3222, or alternatively to an auxiliary I/O device 3228.

A user of UE 3200 may also compose data items such as email messages for example, using the keyboard 3232, which may be a complete alphanumeric keyboard or telephone-type keypad, among others, in conjunction with the display 3222 and possibly an auxiliary I/O device 3228. Such composed items may then be transmitted over a communication network through the communication subsystem 3211.

For voice communications, overall operation of UE 3200 is similar, except that received signals may typically be output to a speaker 3234 and signals for transmission may be generated by a microphone 3236. Alternative voice or audio I/O subsystems, such as a voice message recording subsystem, may also be implemented on UE 3200. Although voice or audio signal output is preferably accomplished primarily through the speaker 3234, display 3222 may also be used to provide an indication of the identity of a calling party, the duration of a voice call, or other voice call related information for example.

Serial port 3230 in FIG. 23 may normally be implemented in a personal digital assistant (PDA)-type UE for which synchronization with a user's desktop computer (not shown) may be desirable, but is an optional device component. Such a port 3230 may enable a user to set preferences through an external device or software application and may extend the capabilities of UE 3200 by providing for information or software downloads to UE 3200 other than through a wireless communication network. The alternate download path may for example be used to load an encryption key onto the device through a direct and thus reliable and trusted connection to thereby enable secure device communication. As will be appreciated by those skilled in the art, serial port 3230 can further be used to connect the UE to a computer to act as a modem.

Other communications subsystems 3240, such as a short-range communications subsystem, is a further optional component which may provide for communication between UE 3200 and different systems or devices, which need not necessarily be similar devices. For example, the subsystem 3240 may include an infrared device and associated circuits and components or a Bluetooth™ communication module to provide for communication with similarly enabled systems and devices. Subsystem 3240 may further include non-cellular communications such as WiFi or WiMAX.

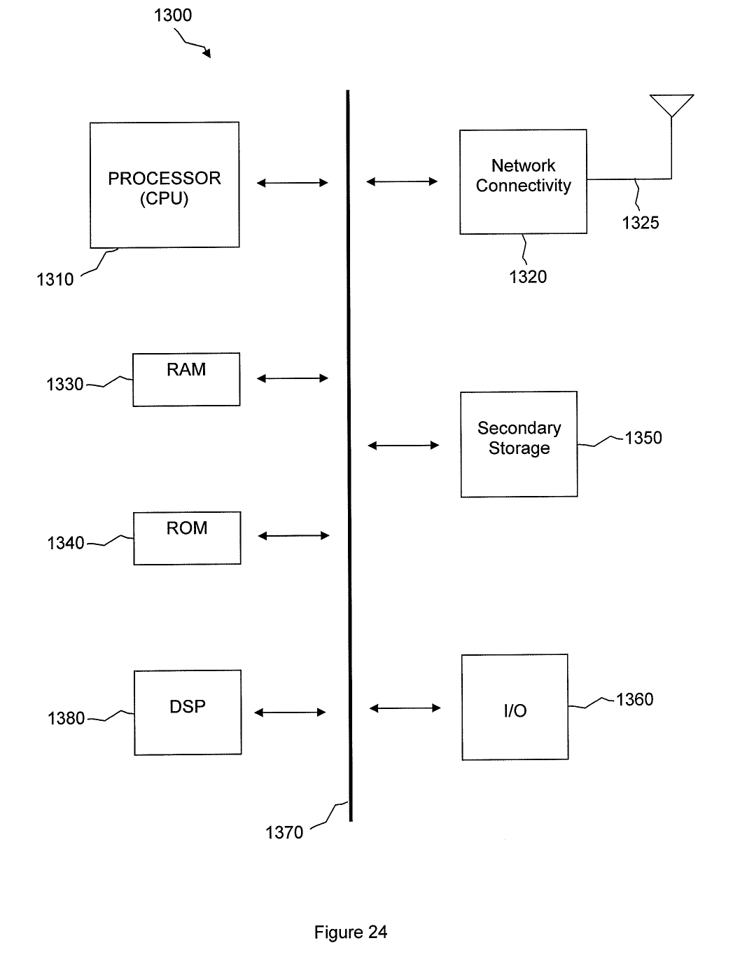

The UE and other components described above might include a processing component that is capable of executing instructions related to the actions described above. FIG. 24 illustrates an example of a system 1300 that includes a processing component 1310 suitable for implementing one or more embodiments disclosed herein. In addition to the processor 1310 (which may be referred to as a central processor unit or CPU), the system 1300 might include network connectivity devices 1320, random access memory (RAM) 1330, read only memory (ROM) 1340, secondary storage 1350, and input/output (I/O) devices 1360. These components might communicate with one another via a bus 1370. In some cases, some of these components may not be present or may be combined in various combinations with one another or with other components not shown. These components might be located in a single physical entity or in more than one physical entity. Any actions described herein as being taken by the processor 1310 might be taken by the processor 1310 alone or by the processor 1310 in conjunction with one or more components shown or not shown in the drawing, such as a digital signal processor (DSP) 1380. Although the DSP 1380 is shown as a separate component, the DSP 1380 might be incorporated into the processor 1310.

The processor 1310 executes instructions, codes, computer programs, or scripts that it might access from the network connectivity devices 1320, RAM 1330, ROM 1340, or secondary storage 1350 (which might include various disk-based systems such as hard disk, floppy disk, or optical disk). While only one CPU 1310 is shown, multiple processors may be present. Thus, while instructions may be discussed as being executed by a processor, the instructions may be executed simultaneously, serially, or otherwise by one or multiple processors. The processor 1310 may be implemented as one or more CPU chips.

The network connectivity devices 1320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, universal mobile telecommunications system (UMTS) radio transceiver devices, long term evolution (LTE) radio transceiver devices, worldwide interoperability for microwave access (WiMAX) devices, and/or other well-known devices for connecting to networks. These network connectivity devices 1320 may enable the processor 1310 to communicate with the Internet or one or more telecommunications networks or other networks from which the processor 1310 might receive information or to which the processor 1310 might output information. The network connectivity devices 1320 might also include one or more transceiver components 1325 capable of transmitting and/or receiving data wirelessly.

The RAM 1330 might be used to store volatile data and perhaps to store instructions that are executed by the processor 1310. The ROM 1340 is a non-volatile memory device that typically has a smaller memory capacity than the memory capacity of the secondary storage 1350. ROM 1340 might be used to store instructions and perhaps data that are read during execution of the instructions. Access to both RAM 1330 and ROM 1340 is typically faster than to secondary storage 1350. The secondary storage 1350 is typically comprised of one or more disk drives or tape drives and might be used for non-volatile storage of data or as an over-flow data storage device if RAM 1330 is not large enough to hold all working data. Secondary storage 1350 may be used to store programs that are loaded into RAM 1330 when such programs are selected for execution.

The I/O devices 1360 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 1325 might be considered to be a component of the I/O devices 1360 instead of or in addition to being a component of the network connectivity devices 1320.

The following are incorporated herein by reference for all purposes: 3GPP Technical Specification (TS) 36.211, 3GPP TS 36.212, 3GPP TS 36.213, and 3GPP TS 36.331.

In an embodiment, a transmission point in a cell in a wireless telecommunication system is provided. The transmission point comprises a transmitter configured such that, in a region that would otherwise carry a PDSCH, the region being defined by a number of resource blocks and a number of OFDM symbols, the transmission point instead transmits at least one of an uplink grant and a downlink assignment in a plurality of OFDM symbols within a first slot, a second slot, or both slots of the region. The region can use either localized or distributed resources, and the region contains one of a transmission point-specific reference signal, a UE-specific reference signal, and a cell-specific reference signal.

In another embodiment, a method for communication in a cell in a wireless telecommunication system is provided. The method comprises, in a region that would otherwise carry a PDSCH, the region being defined by a number of resource blocks and a number of OFDM symbols, instead transmitting, by a transmission point in the cell, at least one of an uplink grant and a downlink assignment in a plurality of OFDM symbols within a first slot, a second slot, or both slots of the region. The region can use either localized or distributed resources, and the region contains one of a transmission point-specific reference signal, a UE-specific reference signal, and a cell-specific reference signal.

In another embodiment, a UE is provided. The UE comprises a receiver configured such that, in a region that would otherwise carry a PDSCH, the region being defined by a number of resource blocks and a number of OFDM symbols, the UE instead receives at least one of an uplink grant and a downlink assignment in a plurality of OFDM symbols within a first slot, a second slot, or both slots of the region. The region can use either localized or distributed resources, and the region contains one of a transmission point-specific reference signal, a UE-specific reference signal, and a cell-specific reference signal.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

While several embodiments have been provided in the present disclosure, it should be understood that the disclosed systems and methods may be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A transmission point in a cell in a wireless telecommunication system, the transmission point comprising:
a transmitter configured such that, in a region that would otherwise carry a physical downlink shared channel (PDSCH), the region being defined by a number of resource blocks and a number of orthogonal frequency division multiplexing (OFDM) symbols, the transmission point instead transmits at least one of an uplink grant and a downlink assignment in a plurality of OFDM symbols within a first slot, a second slot, or both slots of the region, wherein the region can use either localized or distributed resources, and wherein the region contains one of:
a transmission point-specific reference signal;
a UE-specific reference signal; and
a cell-specific reference signal.

2. The transmission point of claim 1, wherein a first resource used to carry a first uplink grant and downlink assignment for a first user equipment (UE) shares a virtual resource block pair with a second resource used to carry a second uplink grant and downlink assignment for a second UE.

3. The transmission point of claim 1, wherein a first resource used to carry a downlink assignment shares a resource block with a second resource used to carry an uplink assignment.

4. The transmission point of claim 1, wherein, when carrier aggregation with cross-carrier scheduling is configured, downlink assignments and uplink grants for different carriers of the same UE are transmitted adjacent to each other.

5. The transmission point of claim 1, wherein the transmission point has a plurality of regions that would otherwise carry a PDSCH and that instead carry at least one of an uplink grant and a downlink assignment, the plurality of regions comprising at least one of:
a transmission point-specific reference signal;
a UE-specific reference signal; and
a cell-specific reference signal.

6. The transmission point of claim 1, wherein a plurality of transmission points jointly transmit physical downlink control channels (PDCCHs) to UEs within the coverage area of the transmission points using a single region that would otherwise carry a PDSCH and that instead carries at least one of an uplink grant and a downlink assignment.

7. A method for communication in a cell in a wireless telecommunication system, the method comprising:
in a region that would otherwise carry a physical downlink shared channel (PDSCH), the region being defined by a number of resource blocks and a number of orthogonal frequency division multiplexing (OFDM) symbols, instead transmitting, by a transmission point in the cell, at least one of an uplink grant and a downlink assignment in a plurality of OFDM symbols within a first slot, a second slot, or both slots of the region, wherein the region can use either localized or distributed resources, and wherein the region contains one of:
a transmission point-specific reference signal;
a UE-specific reference signal; and
a cell-specific reference signal.

8. The method of claim 7, wherein a first resource used to carry a first uplink grant and downlink assignment for a first user equipment (UE) shares a virtual resource block pair with a second resource used to carry a second uplink grant and downlink assignment for a second UE.

9. The method of claim 7, wherein a first resource used to carry a downlink assignment shares a resource block with a second resource used to carry an uplink assignment.

10. The method of claim 7, wherein, when carrier aggregation with cross-carrier scheduling is configured, downlink assignments and uplink grants for different carriers of the same UE are transmitted adjacent to each other.

11. The method of claim 7, wherein a transmission point has a plurality of regions that would otherwise carry a PDSCH and that instead carry at least one of an uplink grant and a downlink assignment, the plurality of regions comprising at least one of:
a transmission point-specific reference signal;
a UE-specific reference signal; and
a cell-specific reference signal.

12. The method of claim 7, wherein a plurality of transmission points jointly transmit physical downlink control channels (PDCCHs) to UEs within the coverage area of the transmission points using a single region that would otherwise carry a PDSCH and that instead carries at least one of an uplink grant and a downlink assignment.

13. A user equipment (UE) comprising:
a receiver configured such that, in a region that would otherwise carry a physical downlink shared channel (PDSCH), the region being defined by a number of resource blocks and a number of orthogonal frequency division multiplexing (OFDM) symbols, the UE instead receives at least one of an uplink grant and a downlink assignment in a plurality of OFDM symbols within a first slot, a second slot, or both slots of the region, wherein the region can use either localized or distributed resources, and wherein the region contains one of:
a transmission point-specific reference signal;
a UE-specific reference signal; and
a cell-specific reference signal.

14. The UE of claim 13, wherein a first resource used to carry a first uplink grant and downlink assignment for a first user equipment (UE) shares a virtual resource block pair with a second resource used to carry a second uplink grant and downlink assignment for a second UE.

15. The UE of claim 13, wherein a first resource used to carry a downlink assignment shares a resource block with a second resource used to carry an uplink assignment.

16. The UE of claim 13, wherein, when carrier aggregation with cross-carrier scheduling is configured, downlink assignments and uplink grants for different carriers are received adjacent to each other.

17. The UE of claim 13, wherein a plurality of regions exist in which a PDSCH would otherwise be received and in which at least one of an uplink grant and a downlink assignment are received instead, the plurality of regions comprising at least one of:
a transmission point-specific reference signal;
a UE-specific reference signal; and
a cell-specific reference signal.

18-74. (canceled)
